(19) United States
(12) Patent Application Publication
(10) Pub. No.: US 2013/0238829 A1
(43) Pub. Date: Sep. 12, 2013

(54) AUDIO DOCKING DEVICES AND SYSTEMS

(71) Applicants: Larry R. Laycock, Alpine, UT (US); Landon T. Laycock, Alpine, UT (US); Logan R. Laycock, Alpine, UT (US)

(72) Inventors: Larry R. Laycock, Alpine, UT (US); Landon T. Laycock, Alpine, UT (US); Logan R. Laycock, Alpine, UT (US)

(21) Appl. No.: 13/415,835

(22) Filed: Mar. 8, 2012

(51) Int. Cl. G06F 13/00

(52) U.S. Cl. 710/303

(57) ABSTRACT

Audio systems are disclosed and include audio docking stations, adapters for connecting to audio docking stations, electronic devices equipped with audio components, and non-electronic articles enabled for use with audio components. An audio docking station may include one or more earphones and an audio input. The earphones and/or audio input may be wireless or include retractable wires. An adapter may act as a sound pouch to connect to the audio docking station. The adapter may be located in clothing, furniture, electronic devices, protective covers or cases, or in other locations. An electronic device may also act as a docking station and include earphones and/or an audio input. Cavities may be pre-formed in the housing of the electronic device for storage of earphones and/or an audio input.

### CROSS-REFERENCE TO RELATED APPLICATIONS

N/A

### TECHNICAL FIELD

The present disclosure relates generally to portable audio devices and systems. Audio devices and/or systems of the present disclosure may particularly, but not exclusively, be used as or in connection with audio docking stations. An audio device or system of the present disclosure may have one or more audio outputs and one or more audio inputs. In one embodiment, an audio output includes a wired or wireless headphone or earphone, while an audio input includes an audio jack or audio receiver. Such an audio device or system may be used in connection with any number of electronic, consumer or other products. In at least one embodiment, storage or other protective cases for electronic devices, consumer products, or other products may also be adapted for integrated use with audio components or capabilities.

### RELATED ART

Conventional electronic devices have largely been developed to satisfy a particular need. This is no more apparent than with a traditional telephone. A user would use the telephone specifically to vocally communicate with a person at a remote location. Other devices developed for specific purposes included traditional radios with FM and/or AM tuners, televisions for receiving and displaying broadcast audio-visual programs, and early computers were developed to process and analyze large quantities of data.

Some of the early breakthroughs in electronic devices related to the miniaturization of components. For instance, advances in semiconductor technology allowed processors, transmitters, receivers, and other electronic components to not only be more easily manufactured, but to be manufactured at a smaller size while maintaining or increasing functionality. As a result, when miniaturized components were added to electronic devices, such devices were no longer required to be generally fixed to a particular location, but could instead be made portable. This paved the way for the widespread use of calculators, portable radios, Walkmans, two-way radios, cellular phones, and other devices. Subsequently, further technological advancements allowed devices to be produced at even smaller sizes and with increased portability. As a result, portable electronic devices such as mp3 players, iPods, PDAs, e-readers, and other devices became commonplace.

Advancements in electronic devices were not only related to reduced size and increased portability, but also provided increased functionality. As a result, the once clear lines between types of devices were blurred. Portable music players could access and play stored digital content, but also included wireless transceivers to access remote data stores and download additional music, send text or other communications to other people, or to browse Internet information. A cellular phone became not only usable to make and receive phone calls, but also included contact management, calendaring and other software for managing many other daily tasks. Indeed, a large percentage of the adult population in the United States currently uses a “smartphone” that can not only manage aspects of the person's home and work life, but can further provide many, if not all, of the same functions previously provided by dedicated devices such as telephones, computers, calculators, PDAs, radios, music players, and personal internet devices.

Because a single device may manage the user's home and work life, the user often has access to the electronic device at almost all times. Whether the person is relaxing, exercising, working, engaging in a recreational activity, or doing some other activity, the user has access to the information the electronic device provides. Often the information is in an audio format, such as where the user maintains a local or cloud-based storage of music files, access a music streaming service, or the like.

To make access of music or other information private, portable electronic devices typically include an audio output port, which output allows the user to connect a hands-free audio device. The hands-free audio device will typically include one or more headphones or earphones connected to a wire that connects to an audio input jack. The audio input jack can mate with the audio output port of the portable electronic device. Typically, audio output ports and audio input jacks are of a generally uniform nature so that a hands-free audio device can be used with many different devices.

To use the hands-free audio device, a user of a portable electronic device typically will carry the portable electronic device along with the hands-free audio device. Often, the wire attached to the earphones will wrap around the portable electronic device, other items in a user's pocket, or around itself to tie itself into tangled knots. Additionally, when the user is using the hands-free audio device, the wire can present a safety issue or simply be inconvenient. For instance, when jogging, cycling, skiing, doing manual labor, or the like, equipment, tools, or even the user's hands or arms may catch on the wire and pull the earbuds or headphones from the user's ears or the audio connector from its jack on the audio device.

### SUMMARY

The present disclosure relates generally to audio devices, systems and apparatus, and to components thereof. In some embodiments, aspects of the present disclosure relate to simplifying access to audio input or output devices—whether such devices are wired or wireless—while also providing for storage of the devices. Embodiments envision integrated storage of audio components, compatibility of audio devices for use with a variety of electronic or even non-electronic devices, and recharging of battery or other power sources. Example embodiments provide for audio input/output devices convenient to use and store, and which are protected from damage or loss.

In accordance with at least one embodiment of the present disclosure, an audio docking station is provided. The audio docking station may include a body defining at least one storage location. An audio output device may be configured to be removably secured within the storage location. Optionally, an audio input device is communicatively linked to the at least one audio output device.

According to one aspect that may be combined with any one or more other aspects or embodiments herein, an audio input or output device includes a wired and/or wireless connection.

According to one aspect that may be combined with any one or more other aspects or embodiments herein, an audio output device or audio input device may be retractable relative to the body of an audio docking station.

According to one aspect that may be combined with any one or more other aspects or embodiments herein, an audio docking station may include attachment means for securing the body to an adapter, sound pouch, protective case, storage or travel case, or other component.

According to one aspect that may be combined with any one or more other aspects or embodiments herein,

According to one aspect that may be combined with any one or more other aspects or embodiments herein, an audio docking station includes one or more earbuds, earphones, headphones, hearing aids, or microphones.

According to one aspect that may be combined with any one or more other aspects or embodiments herein, an audio input device may include a male connector, a female connector, or any combination of male and female connectors.

According to one aspect that may be combined with any one or more other aspects or embodiments herein, the storage location includes a cavity, hole or opening having a shape and/or size corresponding to the shape and/or size of the audio output or input.

According to one aspect that may be combined with any one or more other aspects or embodiments herein, a wireless audio input or output device may be configured to have a battery charged while at the storage location.

According to one aspect that may be combined with any one or more other aspects or embodiments herein, a body or audio output device may define a portion of a portable electronic device, computing device, display device, media card, USB device, universal dock, furniture, a storage case, a carrying case, a laptop skin, a protective case, or wearable items such as jewelry, eyeglasses, sunglasses, or watches.

According to one aspect that may be combined with any one or more other aspects or embodiments herein, an electronic device is provided for and includes a housing along with one or more audio components. An audio component may be within or otherwise associated with the housing and capable of transferring audio data. At least one audio output and at least one audio input may communicatively couple to the audio communication components. A storage compartment may be integrated with the housing and configured to selectively receive an audio output and/or input component in a storage configuration.

According to one aspect that may be combined with any one or more other aspects or embodiments herein, an audio output includes one or more earphones.

According to one aspect that may be combined with any one or more other aspects or embodiments herein, a storage compartment includes a location for selectively maintaining at least one earphone in a storage configuration.

According to one aspect that may be combined with any one or more other aspects or embodiments herein, an audio input includes one or more male audio connectors.

According to one aspect that may be combined with any one or more other aspects or embodiments herein, a storage location selectively maintains one or more earphones in a storage configuration.

According to one aspect that may be combined with any one or more other aspects or embodiments herein, an electronic device is a portable electronic device.

According to one aspect that may be combined with any one or more other aspects or embodiments herein, a portable electronic device is a telephone, a music player, an e-reader, a gaming console, a camera, a laptop computer, a netbook, a tablet, a video camera, a USB device, an external hard drive, a GPS device, a projector, a singing or karaoke machine, a portable radio two-way communication device, an optical disk player, a video player, a Dictaphone, a personal digital assistant, a calculator, a pager, a time piece, a radio alarm clock, or an accessory for an electronic device.

According to one aspect that may be combined with any one or more other aspects or embodiments herein, an accessory for an electronic device includes a remote control, a keyboard, a mouse, a gaming controller, a radio, fixed speakers, detachable speakers, a drafting pad, or a power docking station.

According to one aspect that may be combined with any one or more other aspects or embodiments herein, an electronic device is generally intended to not be portable during use.

According to one aspect that may be combined with any one or more other aspects or embodiments herein, an electronic device is a desktop computing device, a server, or a gaming console.

According to one aspect that may be combined with any one or more other aspects or embodiments herein, an audio output includes a wire connecting the audio output directly or indirectly to an audio communication component, with the wire being retractable with respect to a housing.

According to one aspect that may be combined with any one or more other aspects or embodiments herein, an audio input includes a wire connecting the audio input directly or indirectly to an audio communication component, the wire being retractable with respect to the housing.

According to one aspect that may be combined with any one or more other aspects or embodiments herein, a wireless transmitter or receiver directly or indirectly connects an audio input and/or audio output to an audio communication component.

According to one aspect that may be combined with any one or more other aspects or embodiments herein, a storage compartment provides for powering or charging a wireless component of an audio input or output.

According to one aspect that may be combined with any one or more other aspects or embodiments herein, an electronic device acts as an audio pass through device when the electronic device is in a powered off state.

According to one aspect that may be combined with any one or more other aspects or embodiments herein, an adapter connects to an audio docking station. An example adapter may include a body, a receiving portion and an attachment mechanism. The receiving portion may cooperate with the body to define an area where the adapter connects to an audio docking station. The attachment mechanism can be used to secure the audio docking station to the body.

According to one aspect that may be combined with any one or more other aspects or embodiments herein, the receiving portion may include a cavity, hole or opening.

According to one aspect that may be combined with any one or more other aspects or embodiments herein, the receiving portion may be selectively closeable.

According to one aspect that may be combined with any one or more other aspects or embodiments herein, a receiving portion may have an audio docking station placed or slideably received therein.

According to one aspect that may be combined with any one or more other aspects or embodiments herein, an adapter body may define an opening configured to coincide with placement of one or more earphones or other audio output or input devices that are removable and/or extendable from the audio docking station.

According to one aspect that may be combined with any one or more other aspects or embodiments herein, a receiving portion of an adapter may include a connector corresponding to a location of an audio input or output connector of an audio docking station and configured to communicatively couple the adapter to the audio docking station.

According to one aspect that may be combined with any one or more other aspects or embodiments herein, an adapter is located on or within furniture, clothing, exercise equipment, an electronic device, a storage, carrying or protective cover or case, or vehicles, including at least automobiles, airplanes, marine vehicles, all terrain vehicles, scooters, motorcycles, and bicycles.

Other aspects, as well as the features and advantages of various aspects, of the present disclosure will become apparent to those of ordinary skill in the art through consideration of the ensuing description, the accompanying drawings and the appended claims.

### BRIEF DESCRIPTION OF THE DRAWINGS

In order to describe the manner in which features and other aspects of the present disclosure can be obtained, a more particular description of certain subject matter will be rendered by reference to specific embodiments which are illustrated in the appended drawings. Understanding that these drawings depict only typical embodiments and are not therefore to be considered to be limiting in scope, nor drawn to scale for all embodiments, various embodiments will be described and explained with additional specificity and detail through the use of the accompanying drawings in which:

FIG. 1 is a frontal plan view of an audio docking device in a use or expanded configuration, according to one embodiment of the present disclosure;

FIG. 2 is a frontal plan view of the audio docking device of FIG. 1, with the audio docking device in a storage or retracted configuration, according to another embodiment of the present disclosure;

FIG. 3 is a side plan view of the audio docking device of FIG. 2;

FIG. 4 is a partial interior view of the audio docking device of FIGS. 1-3, with a set of earbuds and an audio input being shown at least partially retracted;

FIG. 5 is a partial interior view of an audio docking device according to another embodiment of the present disclosure, the audio docking device including an audio input, a wireless transmitter, and wireless earbuds;

FIG. 6 is a partial interior view of an audio docking device according to another embodiment of the present disclosure, the audio docking device including a wireless receiver, a wireless transmitter, and wireless earbuds;

FIG. 7 is a partial interior view of an audio docking device according to still another embodiment of the present disclosure, the audio docking device including a wireless transmitter, wireless earbuds, and a connection port;

FIG. 8 is a bottom perspective view of a portable electronic device according to one embodiment of the present disclosure, the portable electronic device having integral earbuds and an integral audio input;

FIG. 9 is a top plan view of a portable telephone consistent with the embodiment illustrated in FIG. 8;

FIG. 10 is a bottom plan view of the portable telephone illustrated in FIG. 9, the earbuds being in an expanded or use configuration;

FIG. 11 is a bottom plan view of the portable telephone illustrated in FIG. 10, the earbuds being in a retracted or storage configuration;

FIGS. 12 and 13 are schematic illustrations of example portable electronic devices according to still other embodiments of the present disclosure;

FIG. 14 is a frontal plan view of a display device having audio devices integrated therewith according to one embodiment of the present disclosure;

FIG. 15 is a top perspective view of a portable computing device according to one embodiment of the present disclosure;

FIG. 16 is a top perspective view of a portable computing device according to another embodiment of the present disclosure, the portable computing device being integrated with an audio accessory;

FIG. 17 is a top plan view of the audio accessory of FIG. 16;

FIG. 18 schematically illustrates the audio accessory of FIGS. 16 and 17;

FIG. 19 is a top plan view of a keyboard computing accessory according to one embodiment of the present disclosure;

FIG. 20 is a side perspective view of a mouse computing accessory according to one embodiment of the present disclosure;

FIG. 21 is a top plan view of a handheld gaming controller according to one embodiment of the present disclosure;

FIG. 22 is a front plan view of a computing device according to one embodiment of the present disclosure;

FIG. 23 is a frontal plan view of an example adapter including a sound pouch for coupling to an audio docking station according to one embodiment of the present disclosure;

FIG. 24 is a frontal plan view of the adapter of FIG. 23, the adapter being integrated with an example audio docking device similar to that illustrated in FIGS. 1-4;

FIG. 25 is a perspective view of an example case for an electronic device, the case having one or more audio devices integrated therewith according to another embodiment of the present disclosure;

FIG. 26 is another perspective view of the example case of FIG. 25, the case being open to expose an electronic device operational therewith;

FIG. 27 is a perspective view of an article of clothing having an adapter for coupling the article of clothing to an audio docking device according to one embodiment of the present disclosure;

FIG. 28 is a perspective view of a backpack configured for use with an audio docking device according to one embodiment of the present disclosure;

FIG. 29 is a perspective view of a chair having a headrest, the chair being configured for use with an audio docking device according to one embodiment of the present disclosure;

FIG. 30 is a perspective view of another embodiment of a chair, the chair having wireless audio components integrated therewith;

FIG. 31 is a perspective view of still another embodiment of a chair, the chair having a set of headphones integrated therewith, and selectively removable therefrom, according to one embodiment of the present disclosure;

FIG. 32 is a perspective view of an example embodiment of a couch having integrated audio components according to one embodiment of the present disclosure;

FIG. 33 provides a perspective view of an audio assembly for use with a person's ear, the audio assembly being at least partially integrated with an earring;

FIG. 34 is a front plan view of a brooch, the brooch having one or more audio devices integrated therewith;

FIG. 35 is a front plan view of a necklace having a pendant, the pendant being configured to provide access to one or more audio devices in accordance with embodiments of the present disclosure;

FIG. 36 is a frontal perspective view of a eyeglasses the eyeglasses having one or more audio devices associated therewith according to one embodiment of the present disclosure; and

FIG. 37 is a top plan view of a wristwatch having one or more audio devices integrated therewith in accordance with another embodiment of the present disclosure.

### DETAILED DESCRIPTION

Aspects of the present disclosure generally relate to audio devices, components and accessories, and more particularly to portable audio devices and systems that can be used in multiple environments and/or in connection with multiple audio systems.

If the specification or claims refer to “an additional” element, feature, aspect, component, or the like, that does not preclude there being exactly one, or more than one, of the additional element. It is to be understood that where the claims or specification refer to “a” or “an” element, such reference is not be construed that there necessarily is only one of that element. It is to be understood that where the specification states that a component, feature, structure, or characteristic “may,” “might,” “can,” or “could” be included, that particular component, feature, structure, or characteristic is not required to be included, but may be optional or non-essentially included in some embodiments of the present disclosure.

Methods of the present disclosure may be implemented by performing or completing selected steps, acts, or tasks manually, automatically, or using a combination thereof. As used herein, the terms “method” or “process” refer to manners, means, techniques and procedures for accomplishing a given task including, but not limited to, those manners, means, techniques and procedures either known to, or readily developed from known manners, means, techniques and procedures by practitioners of the art to which the present disclosure belongs. The descriptions, examples, methods and materials presented in the claims and the specification are not to be construed as limiting but rather as illustrative only.

Meanings of technical and scientific terms used herein are to be commonly understood as by one of ordinary skill in the art to which embodiments of the present disclosure belong, unless otherwise defined. Embodiments of the present disclosure can be implemented in the testing or practice with methods and materials equivalent or similar to those described herein.

Relational terms such as, but not exclusively including, “bottom,” “below,” “top,” “above,” “back,” “front,” “left”, “right”, “rear”, “forward”, “up”, “down”, “horizontal”, “vertical”, “clockwise”, “counterclockwise,” and the like (as well as derivatives thereof) as used herein do not necessarily indicate, for example, that a “bottom” component must be below a “top” component, or that a component that is “below” is indeed under or at a lower elevation than another component, or that a component that is “above” is indeed over or at a higher elevation as compared to another component. Rather, such designations are purely to facilitate reference to various components or elements of example embodiments, including those illustrated in referenced figures. As such, directions, components or relative positioning may be referenced purely for convenience, or may be flipped, rotated, moved in space, placed in a diagonal orientation or position, placed horizontally or vertically, or similarly modified. Accordingly, it will be appreciated that such example terms are to be used herein for differentiation purposes only, to describe the relative positioning or placement of certain components or elements relative to certain embodiments including those in the referenced figures, to indicate a first and a second component, or to do both. Additionally, to differentiate between components, descriptions may refer to certain components or elements using designations such as “first,” “second,” “third,” and the like. Such language is merely provided for differentiation purposes, and is not intended limit a component to a singular designation. As such, a component referenced in the specification as a “first” component may, but need not necessarily, be a same component referenced in the claims as a “first” component.

In general, aspects of the present disclosure relate to audio components and systems. In some embodiments, the audio components include audio input or output devices which may include illustrative examples such as earbuds, earphones, headphones, hearing aids, and the like. These terms are intended to be interchangeable. For instance, when an earbud is described, a headphone, earbud, hearing aid, or any combination of the foregoing is also contemplated. Indeed, while such components are generally considered audio output devices, earbuds, headphones, earphones, hearing aids, etc., when disclosed, may also be replaced or supplemented by audio input devices such as microphones. Thus, an example embodiment disclosed as having two earbuds may instead include any combination of earbuds, earphones, headphones, hearing aids, microphones, or the like.

In order to avoid obscuring the inventive and novel aspects of the present disclosure, certain details that would be apparent to one skilled in the art have been omitted. In particular, aspects of audio components, including a full description of the manners in which earphones operate, have been excluded.

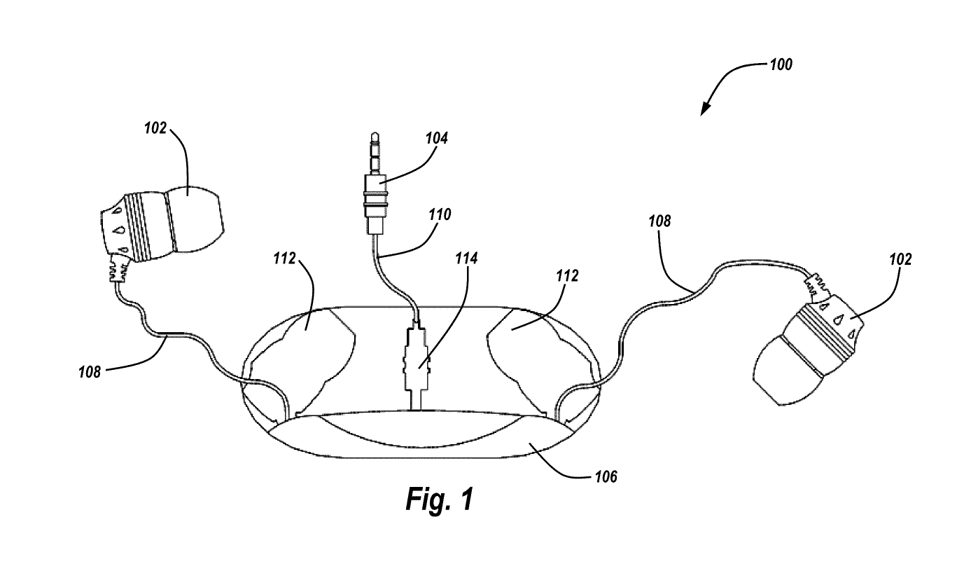

FIGS. 1-4 illustrate example embodiments of an audio docking device 100 according to one embodiment of the present disclosure. In at least some embodiments, the audio docking device 100 may be configured to allow a user to connect one or more audio components to an audio output device, although the audio docking device 100 need not be limited to such a configuration. In other embodiments, the audio docking device 100 may be used with other audio systems, portable electronic devices or systems, or other electronic or non-electronic devices or components.

In the illustrated embodiment, the audio docking device 100 generally includes a set of one or more audio output components such as earbuds 102. The earbuds 102 may be configured to provide sound and audio information to a user. For instance, in one embodiment the earbuds 102 are shaped or otherwise configured to fit at least partially inside the ear of a user so as to transmit sound to the inner ear of the user. In other embodiments, the earbuds 102 may be replaced or supplemented with headphones, earphones, or other audio output components that are positioned wholly or partially inside the ear, on the ear, outside the ear, or in any combination of the foregoing.

In the illustrated embodiment, two earbuds 102 may be electronically and/or communicatively linked to an audio input 104 which is, in this embodiment, in the form of an audio plug or jack. The number of earbuds 102 is merely illustrative. For instance, although two earbuds 102 are illustrated, an audio output component may include only a single output (e.g., a single earbud 102) or in other embodiments three or more audio outputs may be provided. As will be appreciated in view of the disclosure herein, the specific type of audio output may be varied. Indeed, in some embodiments, a single audio docking device 100 may include an audio output component with different types of audio outputs therein.

The audio input 104 may be configured to connect to an audio output port of an electronic or other device. Through such a connection, analog or other sound may be transferred to the audio docking station 100. In the illustrated embodiment, for instance, the audio input 104 may include a male component configured to mate with a female audio output (not shown). Mono, stereo or other sound may be provided. Accordingly, while it should be appreciated in view of the disclosure herein that the audio input 104 may include a stereo plug, a mini-jack, a Bantam plug, a TS connector, a TRS connector, a TRRS connector, another audio connector, or any other combination of the foregoing, the audio input 104 may also take other forms.

In the illustrated embodiment, the audio docking station 100 includes a body 106 for at least partially containing or mounting to the earbuds 102 and/or the audio input 104. For instance, the body 106 may connect to a set of wires 108, 110 that connect to the earbuds 102 and audio input 104, respectively. The wires 108 may extend between the body 106 to the earbuds 102 while the wire 110 extends between the body 106 and the audio input 104. In some embodiments, the wires 108, 110 at least partially define a communication channel by which sound or other input received at the audio input 104 is transferred to the earbuds 102.

The body 106 may be useful for, among other things, storing the earbuds 102 and audio input 104 when the audio docking station 100 is not in use. In other embodiments, the body 106 may have other uses. For instance, in at least one embodiment, the body 106 may be useful for mating the audio docking station 100 to a receiving audio station. The audio docking station 100 may thus have a plurality of arrangements or orientations in which it is useful. For instance, FIG. 1 generally illustrates a use or expanded configuration illustrative of an example configuration in which the audio docking station may be used to receive sound and transfer the sound to a user through the earbuds 102. In this particular embodiment, one or both earbuds 102 may be extended or removed from the body 106 to facilitate placement in, on or around a respective ear of the user. In a similar manner, the audio input 104 may be extended or removed from the body 106 to facilitate a connection with an exterior audio component.

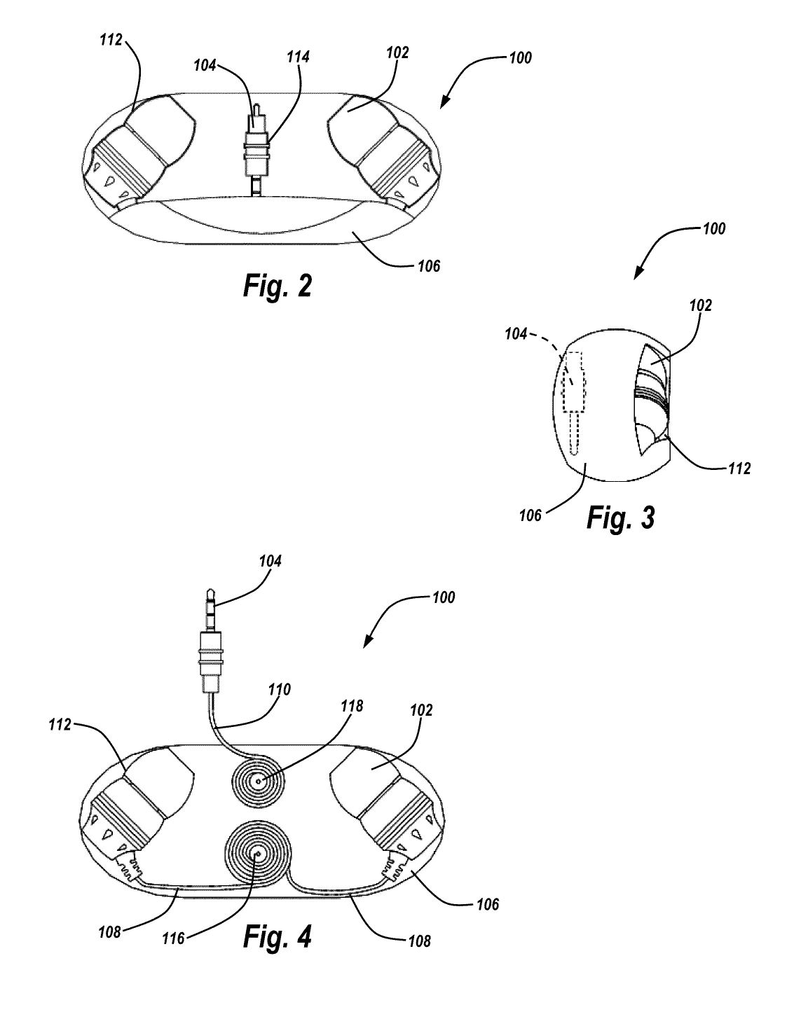

The audio docking station 100 optionally includes a different appearance when in a storage or retracted configuration similar to that illustrated in FIGS. 2-4. More particularly, FIGS. 2-4 illustrate an example embodiment in which the earbuds 102 and/or the audio input 104 have been drawn towards the body 106. More particularly still, in the illustrated embodiment, the earbuds 102 and the audio input 104 are shown in a fully retracted state so as to engage or be drawn fully or partially into the body 106.

To facilitate the retracted or storage position of the earbuds 102 and/or audio input 104, the body 106 optionally defines one or more cavities. For instance, as best shown in FIG. 1, the body 106 may include a set of one or more earbud cavities 112. The earbud cavities 112 are optionally shaped or sized so as to allow the earbuds 102 to be fully or partially drawn therein. In some embodiments, the earbud cavities 112 may be positioned on or near the periphery of the body 106. By way of illustration, the illustrated body 106 is generally oval, and the earbud cavities 112 may generally be positioned at opposing sides of the oval. The earbuds 102 and cavities 112 may also be curved or shaped in a manner to generally conform to the curvature of the body 106. In one embodiment, the earbuds 102 can be positioned in a retracted or storage position in which the earbuds 102 substantially conform to the shape of the body 106 and/or do not substantially alter the footprint size of the body 106. Although the body 106 is illustrated and described as being oval or curved, one skilled in the art should appreciate in view of the disclosure herein that the body 106 may take any number of other regular or irregular shapes, and that the earbuds 102 may be used in connection with any such shape.

In at least some embodiments of the present disclosure, the earbud cavities 112 are shaped and sized in a manner that generally corresponds to the shape and size of the earbuds 102. By way of example, the earbud cavities 112 may be defined in a manner so as to engage the earbuds 102 and form a frictional or interference fit therewith. In one embodiment, resilient or semi-resilient material may be positioned around at least a portion of the earbud cavities 112. When the earbud 102 is pressed against the material, the material may flex so as to not only allow the earbud 102 into the earbud cavity 112, but also to exert a retention force thereagainst. A user may then use his or her hand or finger to exert a force that overcomes the retention force in order to remove the earbud 102 from the earbud cavity 112. Optionally, the body 106 is similarly configured to operate in connection with the audio input 104. For instance, an audio input cavity 114 may be defined by the body 106 and facilitate storage and/or retention of the audio input 104.

While the earbud cavity 112 and/or audio input cavity 114 are optionally storage components shaped and/or sized to correspond to, and to facilitate retention of, the earbuds 102 and audio input 104, respectively, such an embodiment is merely illustrative. In other embodiments, for instance, the earbud cavities 112 may be openings in a surface of the body 106 to allow the earbuds 108 to be fully retracted therein. The shape of the openings may be sized and shaped in a manner allowing retraction of the earbuds 108, but without necessarily including a frictional, interference or other retentive fit. Indeed, a clasp, cover, or other component may also be provided in embodiments in which it is desired to retain the earbuds 102 and/or audio input 104 within, on or proximate the body 106.

FIG. 4 provides a view of an interior portion of the audio docking station 100, and illustrates an example manner in which an audio docking station 100 may be used to store audio components such as earbuds 102 and/or an audio input 104. In the illustrated embodiment, the earbuds 102 are connected to a retraction mechanism 116. The audio input 104 may also be connected to a retraction mechanism 118. The specific operation of the retraction mechanisms 116, 118 may be varied in any number of suitable manners. For instance, in one embodiment the retraction mechanism 116 connects to the wires 108 and includes a rotating shaft or wheel, at least one biasing element, or any other elements or combination of the foregoing. By way of example, a shaft or wheel may be directly or indirectly coupled to the wires 108. A spring or another biasing element may apply a force tending to cause the shaft or wheel to rotate in a manner that causes the wires 108 to accumulate around the perimeter of the shaft or wheel and within an opening inside the body 106. A second biasing mechanism may at least partially offset the spring. By way of example, a user may pull on the earbud 102 or the wire 108 to unroll at least a portion of the wire from the shaft or wheel. The second biasing member may stop the rotation of the shaft or wheel to allow the user to select the extent to which the earbud 102 is retracted. In one embodiment, by again pulling on the earbud 102 or wire 108 and releasing the earbud 102 or wire 108, the second biasing mechanism may be released to allow the spring to again retract the wire 108 and the earbud 102.

While FIG. 4 illustrates an example embodiment in which the earbuds 108 are each connected to a single retraction mechanism 116, it will be appreciated that this is merely illustrative. In other embodiments, for instance, each earbud 108 may be independently expanded or retracted. Additionally, while the audio input 104 is shown as being connected to a second retraction mechanism 118—which optionally operates in a manner similar to that of retraction mechanism 116—the audio input 104 may alternatively be linked to the same retraction mechanism 116 operating in connection with one or more of the earbuds 108.

While FIGS. 1-4 generally relate to an audio docking station 100 that may include one or more audio output devices such as earbuds 102, with such earbuds being substantially visible in the storage or retracted configuration, such disclosure or devices are illustrative only. In accordance with other embodiments, one or more holes or openings may be defined by the body 106 so as to obscure a view of all or any portion of the earbuds 102 in their retracted or storage position. In some embodiments, the earbuds 102 may be totally obscured from view, such as where a cover connects to or fits over the body 106, or in which the earbud cavities 112 are internal and configured to receive the full three dimensional shape of the earbuds.

In accordance with additional or other embodiments, one or more of the earbuds 102 may further be removed to provide a single audio output device, or one or more of the earbuds 102 may be replaced with an audio input device. In at least one embodiment, one of the two illustrated earbuds 102 is an audio output device for positioning in, on or near a user's ear while the other illustrated earbud 102 is instead an audio input device such as a microphone. Such an embodiment may be useful to, for instance, provide two-way communication in connection with a telephone. More particularly, the audio docking station 100 may be connected to a telephone and the microphone positioned to receive sounds provided by the user, while the earbud 102 positioned to convey sounds received by the user from one or more people at the other end of the telephone connection.

Additionally, while the audio input 104 is illustrated as being visible on a same side of the body 106 ad the earbuds 102, such an embodiment is not limiting of the present disclosure. In other example embodiments, the audio input 104 may be otherwise located, such as on a bottom, side or back of the body 106, and even used without the audio input cavity 114 in some cases. In at least one embodiment, decorative or informative information may be formed in, printed on, or otherwise displayed on the body 106. For instance, by moving the audio input 104 to another location, an open area may be provided to include a logo or trademark of a manufacturer or seller of the audio docking station 100.

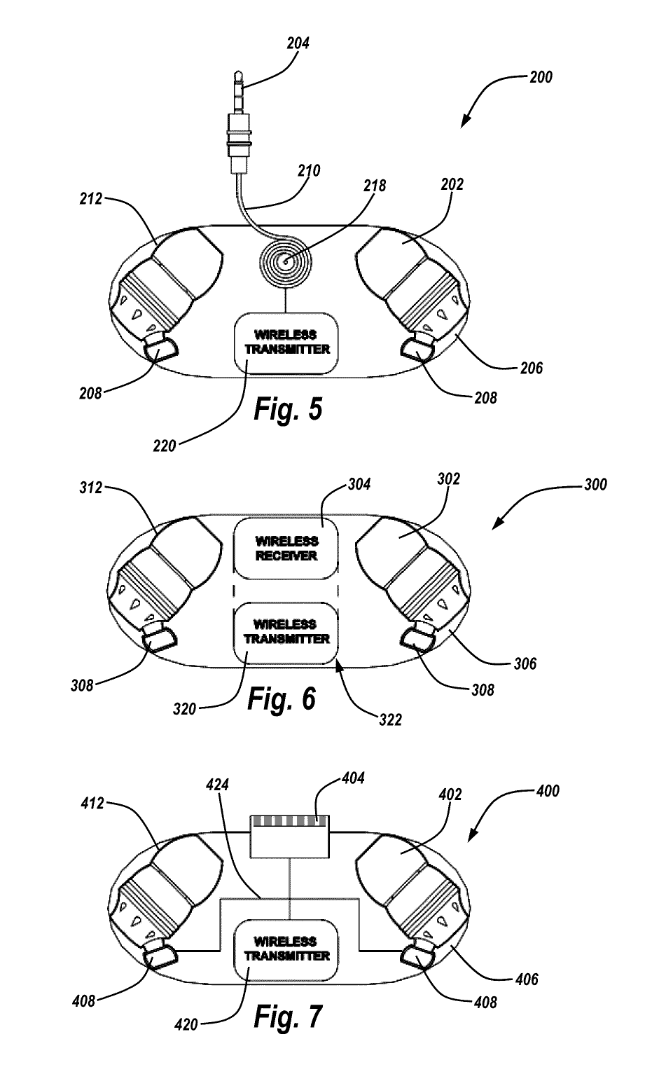

The audio docking station 100 is merely one example of an audio device or system according to aspects of the present disclosure. By way of illustration, additional embodiments of audio docking stations are illustrated in FIGS. 5-7. FIG. 5 is an interior view of an audio docking station 200 according to another embodiment of the present disclosure, the audio docking station 200 including at least one wireless component. More particularly, the audio docking station 200 of FIG. 5 includes wireless earbuds 208 communicatively coupled with an audio input 204 through the use of a wireless transmitter 220.

As shown in FIG. 5, the audio docking station 200 may be generally similar to the audio docking station 100 of FIGS. 1-4; however, rather than providing a wired communication connection fully between the audio input 204 and the earbuds 202, the communication may be accomplished at least partially using a wireless connection. In this embodiment, for instance, the audio input 204 may be connected to a wire 210 which connects to the body 206 of the audio docking station 200 using an optional retraction mechanism 218. In at least one embodiment, the wire 210 is communicatively connected to a wireless transmitter 220. The wireless transmitter 220 may be capable of transmitting signals using any number of different wireless protocols (e.g., Bluetooth, RuBee, WiFi, WPAN, etc.). To receive the transmitted wireless signals, each earbud 202 may include a wireless receiver 208.

Retraction and/or storage of the earbuds 202 and/or audio component 204 may be provided in a manner similar to that described above for the audio docking station 100. In particular, in some embodiments, the body 206 may include or define a set of one or more earbud cavities 212. The earbud cavities 212 optionally are shaped and sized in a manner that corresponds to the shape and size of the earbuds 212 and attached wireless receivers 208. As a result, when one or more earbuds 202 are not in use, the earbuds 202 can be placed in the corresponding cavity 212 and securely stored in a retracted state.

FIG. 6 illustrates an interior view of another embodiment of an audio docking station 300 according to another embodiment of the present disclosure. The audio docking station 300 is similar in some respects to the audio docking stations of FIGS. 1-5; however, in the illustrated embodiment, the audio input 304 includes an optional wireless receiver. The wireless receiver may replace a physical audio jack or connector, and can receive wireless audio signals transmitted from an audio device (not shown). In one embodiment, the audio docking station 300 can act as a relay for audio signals. In particular, the audio signals received by the audio input 304 may be relayed to a set of wireless earbuds 302 using a wireless transmitter 320 of the audio docking station 300. The wireless earbuds 302 may include a wireless receiver 308 that receives signals directed from the wireless transmitter 320.

In some embodiments, the wireless audio input 304 and the wireless transmitter 320 may be separate components that are communicatively coupled using circuits, wires, or other communication channels. In other embodiments, the wireless audio input 304 and the wireless transmitter 320 may be formed in a unitary transceiver 322 or other optional component. Thus, rather than connecting two separate and distinct components, a single transceiver 322 may be capable of both receiving a wireless signal and transmitting the signal, or a transformed version of the signal, to the wireless receivers 308 of the earbuds 302.

In some embodiments, an audio docking station may not require or use an internal or supplemental power supply. For instance, the audio docking station 100 of FIGS. 1-4 may use a wired connection that does not require batteries, an electrical plug or other power supply for operation. Other embodiments, however, may utilize additional power supplies. By way of illustration, the audio docking stations 200, 300 of FIGS. 5 and 6 may include a power supply (not shown) in the way of batteries, electrical connectors (e.g., 110 or 212 Volt plugs, USB connectors, etc.), wind-up mechanisms, solar panels, or the like. The power supply in whatever form may be used to power a wireless component such as a wireless transmitter, receiver, or transceiver. Additionally, one or more power supplies may also be provided for the wireless earbuds 202, 302 in order to power the wireless receivers 208, 308.

According to at least one embodiment, a wireless earbud 202, 302 may have a battery or other similar power supply (not shown), which power supply is optionally rechargeable. With reference to FIG. 6, the earbuds 302 are optionally storable on or within the body 306 of the audio docking station. For instance, one or more cavities 312 may be molded, cut or otherwise formed in the body 306 to allow secure retention of the earbuds 302. In at least one embodiment, the cavities 312 include or otherwise correspond to charging stations of the audio docking device 300. For instance, an electrical connector such as a pin may be aligned with the cavities 312. Power received by the audio docking station 310 from an internal or external source may be passed through the pin or other connector to a corresponding electrical contact of the wireless earbud 302. Such electrical contact may be used to recharge a battery or other power source of the earbud 302.

FIG. 7 illustrates an interior view of another embodiment of an audio docking station 400 which can be used to power wireless components thereof. In the illustrated embodiment, the audio docking station 400 includes a set of wireless earbuds 402 that are selectively connected to a body 406. Mounted to or within the body 604 is a wireless transmitter 420. The wireless transmitter 420 may generally be capable of receiving a signal (e.g., corresponding to sound or other audio) and transmitting the signal or a transformed version of the signal to one or more wireless receivers 408 of the wireless earbuds 402.

In the illustrated embodiment, the audio docking station 400 also includes an input 404 associated with the body 406, wireless transmitter 420 and/or wireless earbuds 408. The input 404 may connect to the body 406 and provide any number of uses. For instance, in one embodiment, the input 404 includes pins or contacts for connecting to an electronic device such as a computer. For instance, the input 404 may be a USB connector that can attach to a mating dock in a computer, portable media device, smartphone, or the like. The input 404 may also include other standard or proprietary forms.

Regardless of the form of the input 404, the pins, contacts or other components of the input 404 may be capable of receiving audio signals and/or a power input. In one embodiment, the input 404 receives both audio and power from an external device or source. Where audio is received, the audio signal can be transferred using a communication link 424 to the wireless transmitter 420, which transmitter 420 can then transmit the signal for receipt by the receivers 408 of the earbuds 402. Where power is received, the power can be transferred using the link 424 to power the wireless transmitter 420. The link 424 optionally also includes connections associated with the earbud cavities 412 or other connectors of the body 406. Such links 424 may allow the wireless earbuds 402 to be placed wholly or partially in or on the body 406 and electrically connected to the input 404. Such connection may provide power to, for example, charge or recharge battery or other power supplies of the wireless earbuds 402.

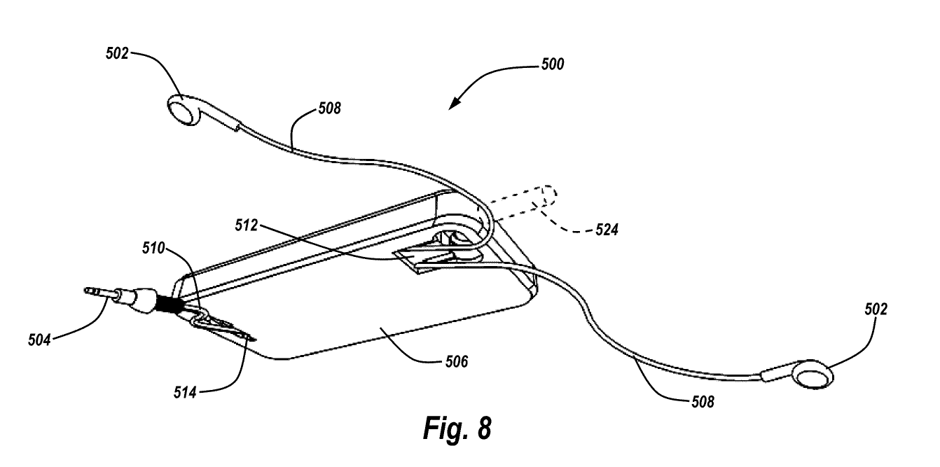

Turning now to FIGS. 8-12, still other embodiments of audio components embodied by the present disclosure are illustrated and described in additional detail. In particular, FIGS. 8-12 illustrate an example portable electronic device 500 having an integrated audio output in the form of earphones 502, as well as an integrated audio input 504.

In FIG. 8, the portable electronic device 500 is representative of a number of different types of devices that may be used in connection with embodiments of the present disclosure. For instance, according to one embodiment, the portable electronic device 500 may be a smartphone or other type of wireless telephone. In other embodiments, the portable electronic device 500 may represent other devices such as mp3 players, music players, e-readers, tablet computing devices, netbooks, portable optical disk players (e.g., DVD, CD, Blu-ray), Internet devices, gaming consoles, portable televisions or other devices, still cameras, video cameras, projectors, singing or karaoke machines, portable radio two-way communication devices (e.g., walkie talkies), video players, Dictaphones, personal digital assistants (PDAs), calculators, pagers, time pieces, radio alarm clocks, or any combination of the foregoing. In some cases the portable electronic device 500 may represent an accessory for an electronic device, an illustrative list of which may include a remote control, a keyboard, a mouse, a gaming controller, a radio, a fixed speaker, a detachable or portable speaker, a drafting pad, a power docking station, or other accessory or any combination of the foregoing.

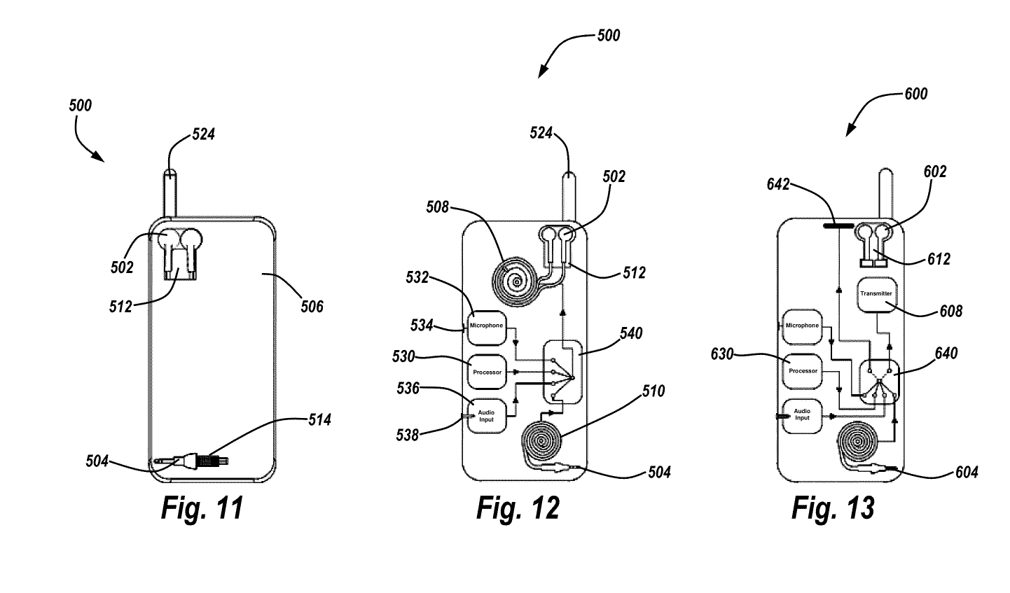

Regardless of the particular form or use of the portable electronic device 500, the portable electronic device 500 may include one or more earphones 502 integrated therewith. In the illustrated embodiment, there are two earphones 502 connected to the portable electronic device 500. Optionally, the earphones 502 are retractable. In one embodiment, for instance, the earphones 502 may retract to a position where they may be stored in a cavity 512 within a cavity body 506 of the portable electronic device 506. An example storage or fully retracted position of the earphones 502 is shown in FIGS. 11 and 12. In other embodiments, a retracted or stored position may have other characteristics. For instance, rather than retracting to a cavity 512, the earphones 502 may simply retract to a position adjacent the body 506. The earphones 502 may also be connected to one or more wires 508 which can retract fully or partially into the body 506 of the portable electronic device 500, optionally using a retraction mechanism that facilitates retraction and/or helps to keep the wires 508 from becoming tangled together. In this manner, the portable electronic device 500 may thus also be an audio docking station similar to those described above with regard to FIGS. 1-7.

The portable electronic device 500 may also include one or more optional audio inputs 504. In FIGS. 8-12 the audio input 504 is illustrated as including a male audio connector similar to a mono or stereo plug as discussed herein. In other embodiments, the audio input 504 may include other male, female or other connectors. Optionally, the audio input 504 also includes a wire 510 or other component and/or is retractable or storable within a cavity 514 of the body 506 of the portable electronic device 500, or in another suitable manner.

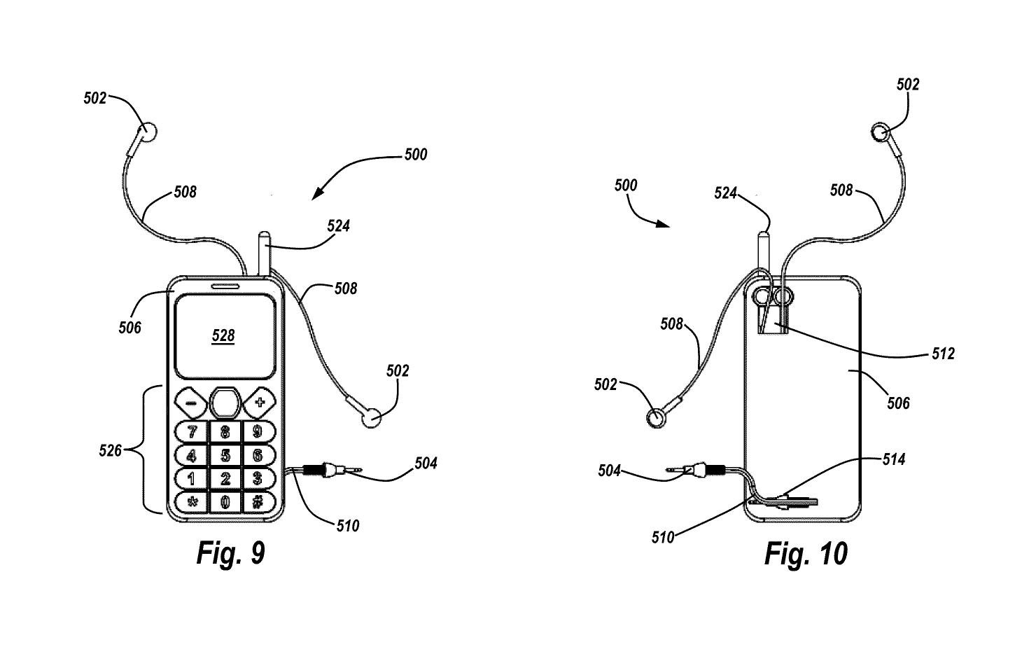

As shown in FIGS. 9-12, illustrated as including a body 506 generally having a rectangular shape, although such shape is merely an example and the body 506 may have any number of other shapes, dimensions, or configurations. The body 506 may house a variety of interior components, including electrical components. For instance, where the portable electronic device 500 is a wireless telephone, one or more input buttons 526 may be provided to make phone calls, select menu options displayed on the display 528, or for any number of other purposes. The input buttons 526 may be physical or software buttons. For instance, in an alternative embodiment, the input buttons 526 may be integrated with the display 528 by including a touch screen input. To facilitate communication with other devices, the portable electronic device 500 may also include an optional antenna 524. The illustrated antenna is shown as protruding from the body 506 of the portable electronic device 500, although this is merely illustrative. In other embodiments, a WiFi, Bluetooth, cellular, or other antenna may be inside the body 506 and allow communication through any of a variety of different communication systems.

The body may also house still other components. For instance, as best shown in FIG. 12, one embodiment of a portable electronic device may include numerous electrical components 530-540. The various components 530-540 may serve a variety of functions. By way of illustration, the portable electronic device 500 may include one or more processors 530. In general, the processors 530 may include semi-conductors or other components capable of reading or executing machine-readable instructions. A processor may, for instance, access information from memory or storage on the portable electronic device 500, or received through the antenna 524. Such information may be processed and sent to a display 528 (FIG. 9), stored, transmitted, or otherwise handled. Other components may also operate in connection with the processor 520. For instance, the processor may also communicate with the audio input 504 and/or the earbuds 502. As shown in FIG. 12, for instance, the portable electronic device 500 may include a communication system 540 that communicatively links the processor to the wires 508 of the earbuds 502, as well as the wire 510 of the audio input 504.

The audio input 504 may be only one example of an audio input to the portable electronic device 500. In FIG. 12, for instance, the processor 530 may communicate with multiple audio inputs. An example audio input is a microphone component 532. The microphone component 532 may include a physical input port 534 which is optionally a female connector configured to connect to a standard or proprietary microphone plug. Additionally, or alternatively, the portable electronic device 500 may also include a second audio input 536. The second audio input 536 can include a physical audio input jack 538, which may also be a female connector that is standard or proprietary in nature. In some embodiments, the input jack 538 may be of a type corresponding generally to the input 504. In other embodiments, the audio input 526 may be replaced with an audio output.

Any or all of the various audio inputs may be communicatively linked. For instance, as noted previously, the processor 530 may be linked through a communication system 540 to the earbuds 502. The communication system 540 may include one or more wires, circuits, multiplexers, gates, and the like to facilitate such communication. In one embodiment, the processor 530 access information from a remote source (e.g., through the antenna 524, over the Internet, etc.) and communicates that information to the earbuds 502. In another embodiment, the microphone 532 receives audio in put through the input port 534. The microphone 532 may also use the same or a different communication system 540 to relay information to the earbuds. Similarly, information received at the input jack 538 of the second audio input 536 may also be communicated through the communication system 540 to the earbuds 502.

One aspect of the embodiment in FIGS. 8-11 is that the portable electronic device 500 optionally acts as an audio relay or pass-through device. For instance, when the electronic device 500 is powered on, audio received through any of the inputs 504, 532, 538 may be passed through the portable electronic device 500 and to the earbuds 502. As noted previously, such operation may occur using the communication system 540, circuits, relays, switches, busses, or any number of types of components or elements. Optionally, the portable electronic device 500 may also act as an audio pass-through device even when in a powered off state. In such an embodiment, the earbuds 502 may receive audio received through the input 504 despite the portable electronic device 5000 being powered down or even being disconnected from a power source. In this manner, the portable electronic device 500 can be used to transfer audio from an audio source regardless of the operative state of the portable electronic device 500. In an illustrative example, when an airplane is taking off or landing and electronic devices are required to be turned off, a passenger using the portable electronic device 100 may nonetheless use the portable electronic device 500 to access audio provided through a headphones jack in the airplane seat.

FIG. 13 illustrates an interior view of an example portable electronic device 600. The portable electronic device 600 is similar in many regards to the portable electronic device 500 of FIGS. 8-12, and the discussion related to the portable electronic device 500 is thus equally applicable to the embodiment of FIG. 13.

The portable electronic device 600 may also include or more components or features in addition to, or as alternatives to, those of the portable electronic device of FIGS. 8-12. By way of illustration, the earphones 602 of the portable electronic device 600 may use wireless technology. In such an embodiment, the earphones 602 may include a wireless transmitter and/or receiver for communicating with a wireless component 608 of the portable electronic device 600. The wireless component 608 is shown as a transmitter in communication with a processor 630; however, the wireless component 608 may also receive information from the one or more earphones 602. In some additional embodiments, the portable electronic device 600 may also include one or more audio outputs 642 in addition to earphones 602. For instance, a speaker 642 may be communicatively linked with the processor 630 or other components through a communication system 640. Optionally, a user of the portable electronic device can selectively determine when audio should be played through the speaker 642 or through the earphones 602. In one embodiment, when the earphones 602 are positioned in a storage location such as cavity 612, the portable electronic device 600 optionally automatically uses the speaker 642 instead of the wireless earphones 602.

In some embodiments, the portable electronic device 600 may also connect to and/or include a power supply. In one embodiment, positioning the earphones 602 in the storage location 612 may be useful to securely retain the wireless earphones 602 in a desired location or position and/or to charge or recharge batteries or other components of the wireless earphones 602.

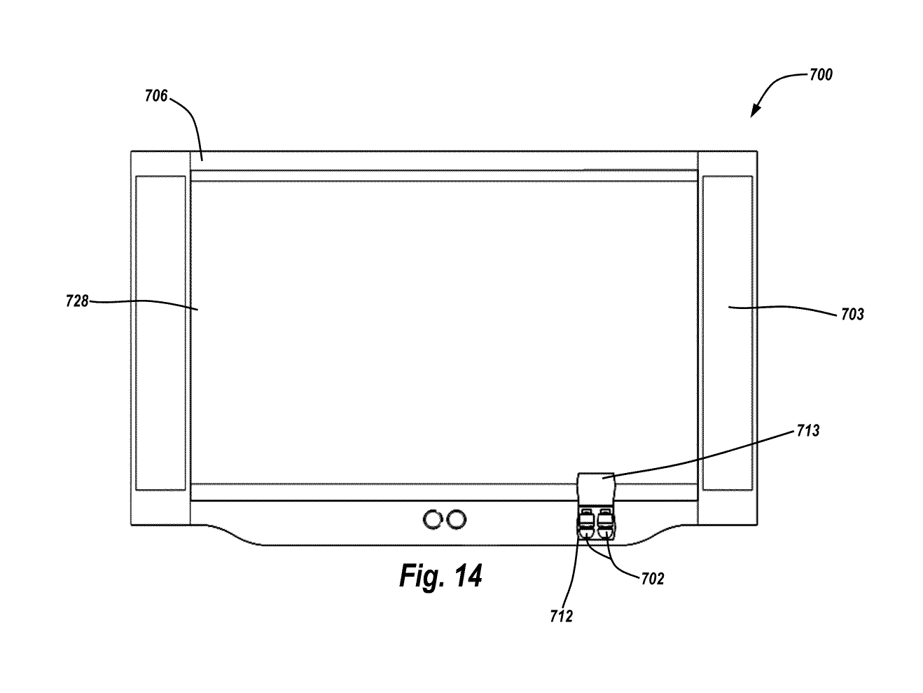

Aspects of the present disclosure may also be encompassed within a variety of types of devices and systems, including both portable and non-portable electronic devices. Turning to FIG. 14 an example audio-visual system 700 is illustrated in which one or more audio outputs 702, 703 may be integrated within an electronic device such as a television or computer monitor. The television, monitor or other audio-visual device may generally be considered non-portable as it is expected to remain in substantially one location during use. In other embodiments, the audio outputs 702, 703 may be incorporated into a portable audio-visual system optimized or configured to move while in use.

In the illustrated embodiment, the audio-visual system 700 has a frame 706 generally defining the shape of the audio-visual system 700. In this embodiment, a display 728 is formed on or within the frame 706. The display 728 may be configured to display audio-visual images received from broadcast, cable, satellite or Internet television sources, from a computer or other electronic device, from some other source, or from any combination of the foregoing. The display 728 may be based on any suitable technology, including LCD, plasma, rear projection, CRT or other display technologies.

Also defined by the frame 706 of the illustrated embodiment is a cavity 712. In this embodiment, the cavity 712 is configured to accept and receive two audio output devices 702, which are illustrated in FIG. 14 as being earbuds. The cavity 712 may generally be sized and structured to receive the earbuds 702, and an optional closure 713 may allow the cavity 712 to be selectively opened or closed. In one embodiment, the cavity 712 includes pre-formed depressions shaped to allow the earbuds 712 to be positioned therein. Optionally, the earbuds 702 are wireless and positioning of the earbuds 702 in respective cavities may charge a battery or other power source of the earbuds 702.

Additional audio outputs 703 may also be provided by the audio system 700. In one embodiment, the audio outputs 703 are loudspeakers. Operation of the loudspeakers 703 may be independent of the earbuds 702 or in concert therewith. For instance, if the display 728 has a picture-in-picture mode, the earbuds 703 may provide audio for one picture while the loudspeakers 703 provide audio from another picture. In another embodiment, a sensor may be included to detect when the earbuds 702 are in the cavity 712 or in use. When the earbuds 702 are in use, the audio to the loudspeakers 703 may automatically be shut off. The automatic shut-off of the audio may be overridden or configured by a user.

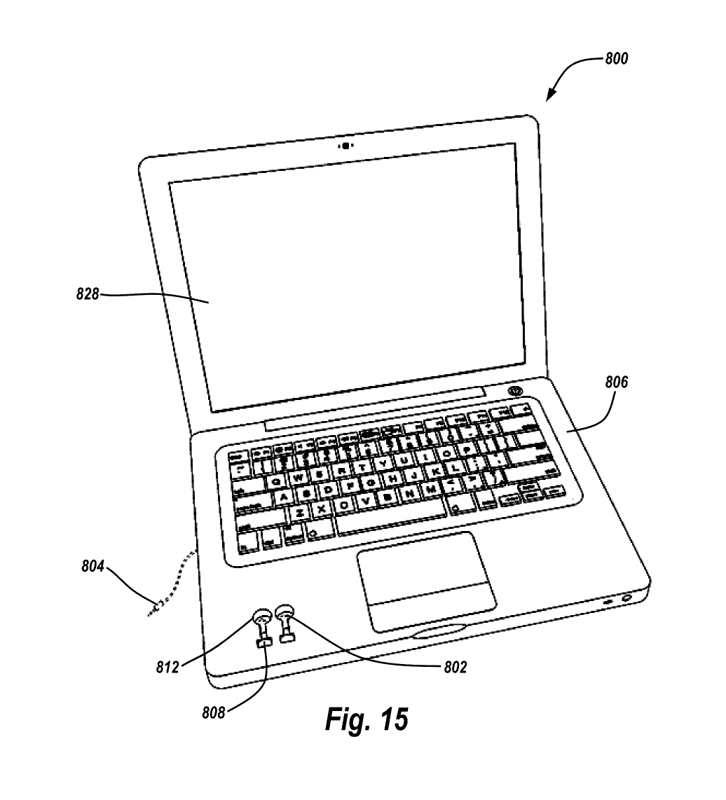

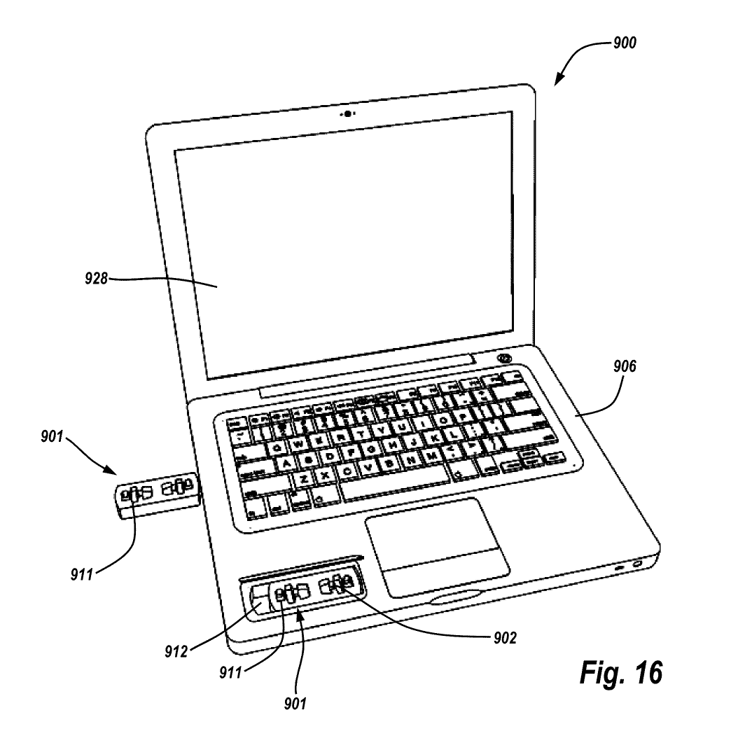

FIGS. 15 and 16 illustrate additional example audio systems that may be used in connection with embodiments of the present disclosure. In particular, FIGS. 15 and 16 illustrate example portable computing devices 800, 900 representative of any number of devices such as laptops, netbooks, tablet computing devices, e-readers, portable media players, or a variety of other devices.

In FIG. 15, the portable computing device 800 includes a display screen 828 that may be used to present visual material. The visual material may include television or recorded programming, computing application data, graphical user interfaces, and the like. A shell 806 of the portable computing device 800 may connect to or house the display 828, and may also house other components such as processors, storage devices, media readers, communication components, and any number of other components or systems. In accordance with one embodiment, the portable computing device 800 may be capable of providing sound and audio to a user of the device. Sound may be provided through one or more speakers (not shown) or through a headphones jack or port (not shown).

In another embodiment, the shell 806 may be designed to operate with one or more integrated audio output components. In FIG. 15, for instance, the shell 806 includes two cavities 812 shaped in a manner that allows two earbuds 802 to be positioned therein. When a user does not use the earbuds 802 to receive audio, the earbuds 802 may be stored in the cavities 812. Optionally, the cavities 812 provide storage and/or provide power sufficient to charge the earbuds 802 as discussed herein, which charging may also be generally simultaneous with charging of the portable computing device 800. For instance, the earbuds 802 may each include a wireless receiver 808 that uses power. When the earbuds 802 are removed from the shell 806—and optionally powered on—the receiver 808 may receive signals from a corresponding audio transducer and transmitter of the portable computing device 800. In other embodiments, the earbuds 802 may connect to a conductive wire that extends between the earbuds 802 and the portable computing device 800. The conductive wire is optionally retractable within the shell 806 of the portable computing device 800 in any suitable manner, including in a manner similar to that disclosed previously with respect to FIGS. 1-5 and 8-13.

The portable computing device 800 also non-essentially includes an audio input 804. The audio input 804 may be a male headphones, mono, stereo or other plug or connector. The audio input 804 may include a conductive wire and such wire may be retractable as described herein. The audio input 804, if included, may also be varied in any number of manners. For instance, the audio input 804 may include a wireless transmitter corresponding to a wireless receiver in the computing device 800. Thus, audio received by the audio input 804 can be wirelessly transmitted to the computing device 800, which device can then transfer the sound to the earbuds 802 also using wireless or wired communication. In some embodiments, the audio input 804 also retracts or can be positioned within a cavity or other storage location in the shell 806.

While FIG. 15 illustrates a portable computing device 800 configured to directly store earbuds 802 in a manner that is integral to the design and/or operation of the portable computing device 800, it should be appreciated that this embodiment is merely illustrative of some embodiments of the present disclosure. In other embodiments, other devices or components may be utilized in a similar manner. For instance, earbuds 802 may be modular in nature or otherwise interchangeable with other components such as earphones, headphones, microphones, hearing aids, audio transducers, and other components used to input or output audio data. In other embodiments, projectors, cameras, other visual input or output devices, or any other device or combination of the foregoing may be integrated with the portable computing device 800 in addition to, or instead of, the earbuds 802.

In accordance with at least one embodiment of the present disclosure, rather than include a cavity, shelf, or other storage compartment directly shaped or sized for the earbuds 802 (or other audio or visual component), the storage compartment may be of a more universal nature. For instance, FIG. 16 illustrates an example portable computing device 900. The portable computing device 900 includes a shell 906 generally defining the housing for the device 900. The shell 906 also defines a storage compartment 912 in this embodiment. Such storage compartment 912 may be used to store any number of components, including storage devices, audio devices, video devices, power supplies, and the like.

In the illustrated embodiment, the storage compartment 912 may be selectively opened or closed. When the storage compartment 912 is in an open state—as shown in FIG. 16—an optional accessory 901 is revealed as being housed therein. In accordance with one embodiment, the accessory 901 includes one or more earbuds 902 located within one or more receiving portions 911. The earbuds 902 and accessory 901 may simply be placed in the storage compartment 912 for storage. In other embodiments, however, the storage compartment 912 may further facilitate use of the earbuds 902. For instance, in one embodiment the connector is exposed within the storage compartment 912. The optional connector may have a standard or proprietary configuration. By way of illustration, suitable connectors may use USB, Serial, i.Link, firewire, video, stereo, SC, ST, or other connectors.

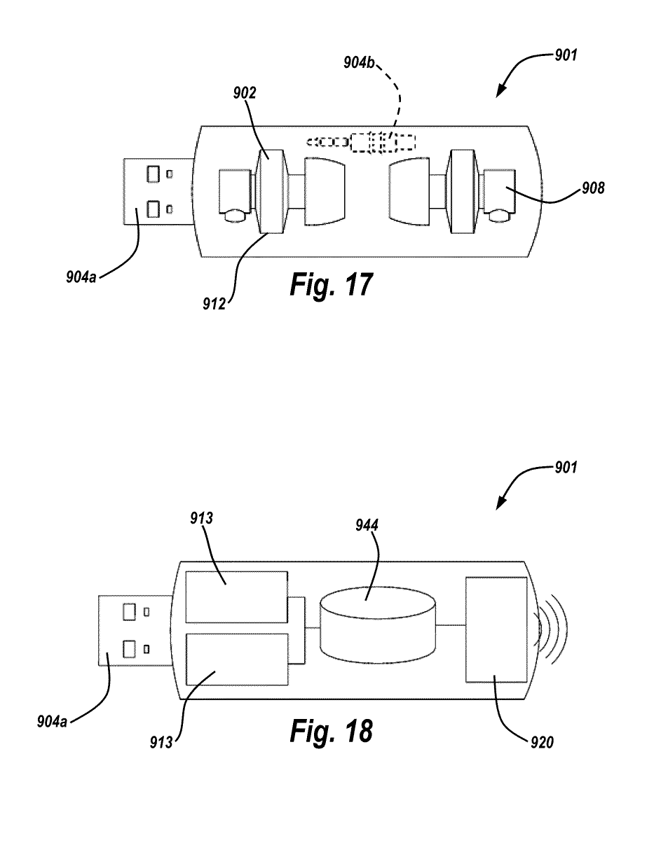

Regardless of the particular type of connector, a corresponding connector may be provided by the accessory 901. For instance, as best shown in FIG. 17, a connector 904a may have a male USB type “A” connector may be provided by the accessory 901. Such a connector 904a may then mate with a corresponding female type “A” connector cooperating with the storage compartment 912. Additionally, or alternatively, an audio input 904b may be provided. The illustrated audio input 904b may be a male stereo plug to mate with a corresponding female audio jack of the storage compartment 912.

By providing the connector within the storage compartment 912, the accessory 901 may be conveniently used with the portable computing device 900. In some cases, accessories are connected to a computer or other device using a port or connector on the outer periphery of the device. For instance, in FIG. 16, the accessory 901 is alternatively shown connected to a connector on the left side of the portable computing device 900. While such use is acceptable and usable in connection with various embodiments disclosed herein, a user may in some cases desire to avoid using an accessory that will stick out from the device. Such desire may be based on a desire to minimize the footprint size of the device, decrease the chance that the accessory 901 will become dislodged or broken through inadvertent contact, or for any number of other reasons. By including a connector within the storage compartment 912, the accessory 901 can be moved out from the side of the portable computing device 900 and to a more secure location in which the accessory is less likely to be bumped, jarred loose, or damaged.

The illustrated example of the accessory 901 and storage with the portable computing device 900 is merely illustrative of one of the many manners in which audio components may be integrated with a portable computing device and/or an accessory. For instance, in other embodiments, one or more of the earbuds 902 may be integrated with a memory card other than a USB or other similar device. Such an accessory may connect to a port within the portable computing device 900, with the connection or removal being facilitated by a biasing mechanism. By way of example, the connection may be spring loaded to ease removal of the accessory from a computer, camera, gaming console, or other electronic device. Such a connection may be provided within the storage compartment 912, or in another location. For instance, the illustrated accessory 901 on the side of the computing device 900 may correspond to the location of a cavity in which the accessory 901 may be inserted and slid therein so as to eliminate or reduce the amount by which the accessory 901 extends from the side of the device 900. A connector such as a USB or other similar connector, as well as a biasing member, may individually or collectively also be considered examples of means for attaching an audio docking station such as accessory 901 to an adapter (e.g., storage compartment 912) or a sound pouch.

A more particular discussion of an example accessory 901 is provided with reference to FIGS. 17 and 18, in which respective top plan and schematic views of the accessory 901 are provided. As shown in FIGS. 17 and 18, an example accessory 901 may be an audio docking station that can connect to a portable or non-portable electronic device. As discussed herein, such a connection is optionally performed using one or more connectors 904a, 904b that mate with corresponding connectors, ports, or jacks of the electronic device. In at least one embodiment, the audio docking station includes one or more audio input/output devices such as earbuds 902. The earbuds 902 may be configured for wireless or wired use. For instance, in a wired configuration, conductive wires may tether the earbuds 902 to the accessory 901. In a wireless configuration the earbuds 902 may include an audio transducer component, such as a wireless receiver 908, that communicates with a wireless transmitter 920. Although FIG. 18 illustrates the wireless transmitter 920 being included in the accessory 901, it should also be appreciated that the wireless transmitter 920 may alternatively be included in a corresponding electronic device.

In operation, a user may connect the accessory 901 to an electronic device and remove one or more of the earbuds from the earbud cavities 913, and place them in his or her ears. Audio data that is generated by the electronic device, or passed through the electronic device, may be passed into the accessory 901 through a corresponding audio input 904a, 904b. The inputs 904a, 904b may be communicatively coupled to the wireless transmitter 920. Information transmitted by the wireless transmitter 920 may be received by the wireless receivers 908 of the earbuds 902 and used to generate sound in the earbuds 902.

The accessory 901 may also include additional or other components. For instance, as shown in FIG. 18, an accessory 901 may include optional storage 944. In one embodiment, the storage 944 may store information that enables use of the earbuds 902, or audio data that can be supplied to the earbuds 902. For instance, software, firmware or other executable instructions may be stored to control operation of the wireless transmitter 920 or the user preferences associated with the accessory 901. The storage 944 may also store audio files such as music, audio books, lectures, podcasts or other audio data, or any combination of the foregoing. Thus, the accessory 901 may not only provide audio outputs to listen to audio signals, but at least some of the audio data may be stored in an accessory integral with the audio outputs.

As will be appreciated in view of the disclosure herein, the accessory 901 may also include still other additional or alternative components. By way of illustration, the accessory 901 may include power components. Batteries or other power supplies may be included and/or charging stations or contacts may be included. For instance, the earbud cavities 912 may include electrical contacts that mate with corresponding leads or contacts of the earbuds 902. Such electrical contact may allow charging of a battery or power supply in the earbuds 902. In still other embodiments, power may be input through the inputs 904a, 904b to power or charge an audio component such as the wireless transmitter 920 or the wireless receivers 908. In still other embodiments, display and/or interface components may be provided so as to allow the accessory 901 to operate in a self-contained manner. For instance, an interface may allow a user to select an audio file stored in the storage 944 and have that information conveyed to the earbuds 902 in a wireless (e.g., using transmitter 920 and receivers 908) or wired (e.g., a retractable conductive wire) manner.

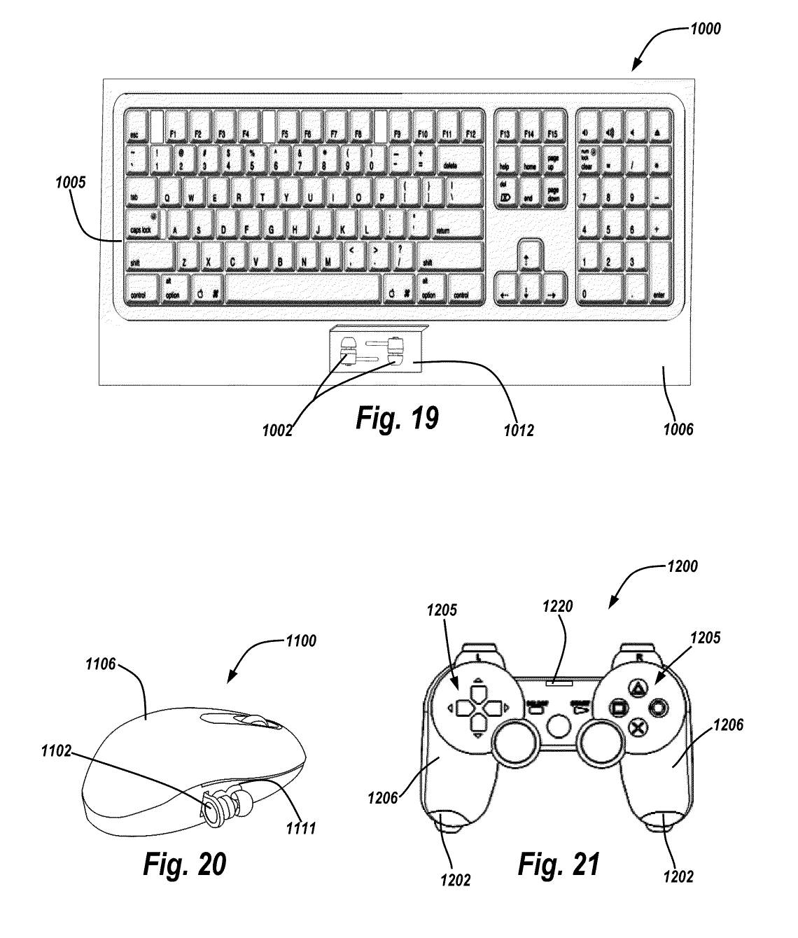

Embodiments of the present disclosure are not limited to use with any particular accessory, but may instead be incorporated or used in connection with any number of different types of accessories for computing devices or other electronic devices. FIG. 19, for instance, illustrates an example computing accessory 1000 in the form of a keyboard. More particularly, the accessory 1000 includes a housing 1006. The housing 1006 may define one or more receiving or connection portions that allow connection of various components, such as a key array 1005. The keys of the key array 1005 may be used to provide input to a computing device or other electronic device.

The housing 1006 of the illustrated embodiment may also include other portions. In FIG. 19, for instance, the housing 1006 devices a compartment 1012. The illustrated compartment 1012 is an example of any number of different types of compartments. For instance, the illustrated compartment 1012 may be on an upper surface and include a sliding or hinged door which exposes an interior compartment. In other embodiments, the storage compartment 1012 may be on other side, rear or even bottom surfaces of the housing 1006. A compartment 1012 may not also have a door as illustrated, but instead may have any other suitable mechanism for securing or protecting the contents of the compartment 1012. In other embodiments the compartment 1012 may remain open.

As shown in FIG. 19, the compartment 1012 may have one or more earphones 1002 that are storable therein. The earphones 1002 are illustrative of other earphones described herein. Thus, in some embodiments, the earphones 1002 may be retractable or may be wireless. Where such earphones 1002 are wireless, the housing 1006 may also house a wireless transmitter to transmit data to corresponding audio receivers of the earphones 1002. In some embodiments, while the earphones 1002 are in the compartment 1012, the earphones 1002 may receive power to provide a charge or boost to electrical storage, such as by recharging a battery of the earphones 1002.

FIG. 20 illustrates another example computing accessory 1100 usable in accordance with some embodiments of the present disclosure. As shown in FIG. 20 the illustrated accessory 1100 may optionally be an input/output device such as a computer mouse. In such an embodiment, the mouse may include some typical components such as a body 1106 that also functions as a grip for a user. Other components such as trackballs, buttons, rollers, optical sensors, or other components may also be integrated into a wired or wireless version of the accessory 1100.

In accordance with some embodiments, the accessory 1100 may be configured for use with one or more audio devices. In at least one example embodiment, the body 1106 of the mouse computing accessory 1100 may include a receiving portion 1111 configured to receive at least a portion of an earphone 1102. The receiving portion 1111 may include an optional opening, door, depression, snap fit, or other feature that can allow the earphone 1102 to be selectively attached thereto. In some embodiments, the earphone 1102 is positioned in a manner so as to have minimal interference with a user's grip of the body 1106. Thus, the receiving portion 1111 may be on a side of the body 1106, although in other embodiments the receiving portion 111 may instead be located on a bottom surface, rear surface, or other location of the accessory 1100.

In at least one embodiment, the earphone 1102 may be selectively removed from the receiving portion 1111 and used by a user to obtain audio information. Such information may be received from any number of sources. In at least one embodiment, the accessory 1100 may receive audio data and pass the audio data to the earphone 1102 by using wired or wireless technologies such as those described herein. More particularly, the earphone 1102 may be connected to the accessory 1100 using a retractable wire. Alternatively, a wireless transmitter may be included within the accessory 1100 so as to wirelessly transmit data to the earphone 1102. It should also be appreciated that while a single earphone 1102 is illustrated, such is for convenience only. In other embodiments, multiple earphones may be connected to a single accessory 1100.

FIG. 21 illustrates still another computing accessory 1200 in accordance with embodiments of the present disclosure and which is usable for providing audio to a user. In the illustrated embodiment, the computing accessory 1200 has the form of a gaming controller, and incorporates multiple different actuators 1205 that can provide input for use in a gaming environment. Such actuators may include buttons, analog sticks, D-Pads, or any number of other types of actuators.

In the illustrated embodiment, the body of the accessory 1200 also includes a set of hand grips 1206. The hand grips may generally provide a user with comfort while using the accessory 1200. In at least one embodiment of the present disclosure, the grips may include receiving areas for selectively receiving and/or storing one or more audio devices. Such devices may include earphones 1202 that are selectively removable. As disclosed herein, earbuds 1202 may be secured in place using a number of different mechanisms, and may optionally be removed from the receiving area while remaining connected to the accessory 1200 in a physical or communicative manner. Such connections may include wired or wireless communication connections. In one embodiment, the controller accessory 1200 includes a wireless transmitter 1220 which can transmit audio data to wireless earphones 1202.

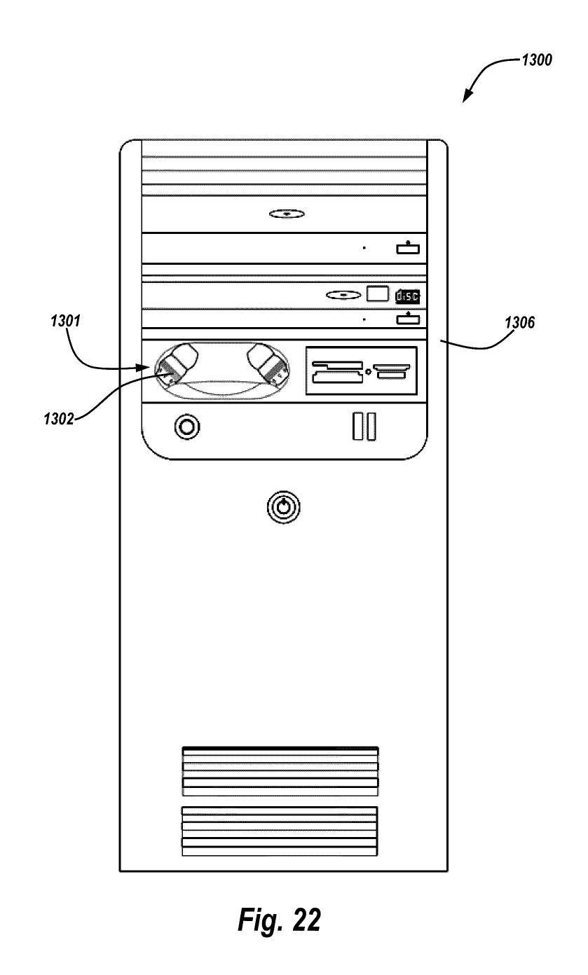

As discussed herein, audio devices, accessories, and docking stations of the present disclosure may be used in connection with any number of electronic devices. A further example electronic device which may be used in such a system is illustrated in FIG. 22. FIG. 22 generally represents a computing device that is not specifically intended for portable use. The computing device 1300 of FIG. 22 represents any number of special or general purpose computing devices. Example devices may include, but are not limited to, servers, desktop computing devices (e.g., general purpose computing devices using WINDOWS™, iOS™, LINUX™ or UNIX™ operating systems), dedicated gaming consoles (e.g., NINTENDO™, XBOX™ PLAYSTATION™ or other systems), home automation systems, landline telephony systems, an appliance, or other systems or any combination of the foregoing.

In the illustrated embodiment, the computing device 1300 includes a housing 1306 which generally defines the shape of the device 1300. Within the housing, or attached directly or indirectly thereto, there may be additional components specific to the type of device, including card readers, optical disk readers, input devices, user interfaces, power supplies, and the like. In one embodiment, ports or connectors may be provided. For instance, a connector may be provided to allow the accessory 901 of FIGS. 16-18 to be used with the computing device 1300.

In accordance with some embodiments, an audio docking station 1301 or other audio accessory may be used in connection with the computing device 1300. In some embodiments the audio docking station 1301 may be integrally formed with the computing device 1300. For instance, the housing 1306 may be molded, machined or otherwise formed to include the audio docking station 1301 and components thereof. For instance, the audio docking station 1301 may be formed with a set of one or more earbud cavities to house the earbuds 1302, microphones, or other audio components. In other embodiments, the audio docking station 1301 may be formed separately relative to the computing device 1306, but permanently connected thereto. For instance, the audio docking station 1301 may be secured to an opening in the housing 1306 using an adhesive, welding, bonding or other process not intended to allow or facilitate removal of the audio docking station 1301. In still other embodiments, the audio docking station 1301 may be selectively and/or removably coupled to the computing device 1300.

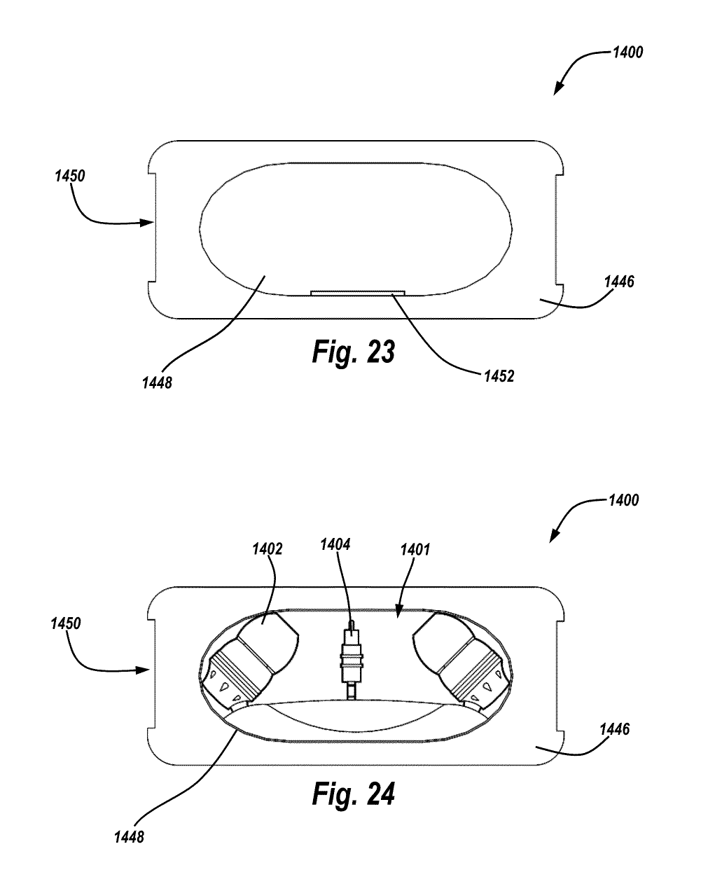

Referring now to FIGS. 23 and 24, an example manner in which an audio docking station 1301 may be selectively and/or removably coupled to a corresponding device, system or apparatus is described in additional detail. The example systems of FIGS. 23 and 24 may be used in connection with any number of electronic and non-electronic devices and systems, a non-exclusive list of which are included herein or would be appreciated by one skilled in the art in view of the disclosure herein.

FIG. 23 illustrates a frontal plan view of an example adapter 1400 that may be used to connect an audio docking station to a desired device, system or apparatus. In some embodiments, the adapter 1400 may contain the audio docking station and be referred to as a sound pouch, although the adapter 1400 may operate in any suitable manner.

In at least one embodiment, the adapter 1400 may include a sleeve portion 1446 that generally defines the shape of the adapter 1400. The sleeve portion 1446 may define an opening 1448, which opening 1448 may provide a base for locating a corresponding audio docking station. Optionally, the opening 1448 may be in communication with one or more secondary openings 1450. As discussed in greater detail herein, the opening 1448 may generally be used to attach the sleeve 1446 to the audio docking station while the secondary openings 1450 may facilitate use of one or more components of the audio docking station. For instance, earbuds or other audio output or input devices may be extended through the secondary openings 1450.

FIG. 23 illustrates an example adapter 1400 configured to couple to an audio docking station while FIG. 24 illustrates the same adapter 1400 in use once coupled to an audio docking station 1401. To facilitate attachment of the audio docking station to the adapter 1410 and/or the sound pouch 1446, the adapter 1410 and/or the audio docking station 1401 optionally includes one or more attachment mechanisms 1452. Any suitable component may be used as an attachment mechanism 1452. For instance, in one embodiment, the audio docking station 1401 may be formed of a rigid material. The attachment mechanism 1452 may be biased using a spring or other component. To insert the audio docking station 1400 into the opening 1448, the attachment mechanism 1452 may be depressed. When the audio docking station 1400 is in place, the attachment mechanism 1452 may at least partially return to its biased position, which can create a frictional fit between the accessory 1400 and the audio docking station 1401. The frictional force may be sufficient to hold the audio docking station 1401 in place, but low enough to allow a user to overcome the force to remove the audio docking station 1401. In some embodiments, the audio docking station 1401 may include a recess or slot therein to receive the attachment mechanism 1452. In some cases, a button release or other component may be provided to facilitate release of the attachment mechanism 1452 and removal of the audio docking station 1401.

The attachment mechanism 1452 may also have any other suitable form or element. For instance, the attachment mechanism 1452 may include a hook-and-loop fastener component, with a corresponding component on the audio docking station 1401. Still other attachment mechanisms 1452 may include mechanical fasteners such as pins, slots, tabs, hooks, clips, snaps, and zippers as well as magnetic attachment devices. Accordingly, it should be appreciated in view of the disclosure herein that any number of suitable devices or components may be used as the attachment mechanism 1452, any or all of which are illustrative examples of a suitable means for attaching the audio docking station 1401 to the adapter 1400 or a sound pouch.

In accordance with some embodiments of the present disclosure, the audio docking station 1401 may be considered a universal audio docking station due to its ability to be utilized in connection with a number of different devices or systems. For instance, the adapter 1400 need not be a stand-alone device as illustrated in FIG. 23. Rather, the adapter 1400 may be included in any number of other devices. For instance, the computing device 1300 may have the adapter 1400 of FIG. 23 built therein to allow the audio docking station 1301 to be selectively used therewith. As a result, when a user is utilizing the computing device 1300, the user can selectively connect the audio docking station thereto and utilize the corresponding audio input/output devices of the audio docking station. In some embodiments, the adapter 1400 may include openings, ports, jacks, or components to allow a wired (e.g., audio input 1404), wireless or other audio input of the audio docking station 1401 in order to establish an electrical or communicative connection between the adapter 1400 and the audio docking station 1401. In some embodiments, connecting the audio docking station 1401 to the adapter 1400 automatically also creates a connection between the audio docking station 1401 and a corresponding electrical device or other apparatus or system.

Before or after establishing a physical and/or audio connection between the audio docking station 1401 and the adapter, the user may remove or extend the earbuds 1402 of the audio docking station 1401. The earbuds 1402 may be removed in any suitable manner depending on the manner in which they are stored by the audio docking station 1401. For instance, manual force, a button release, or another mechanism may overcome a force holding the earbuds 1402 in place on or in the audio docking station 1401. In other embodiments, a window may be opened to allow removal of the earbuds 1402.

As discussed herein, the earbuds 1402 may receive audio through a conductive wire or a wireless component such as a wireless receiver. In a wired embodiment, the earbuds 1402 may be extended from the audio docking device 1401 and through the opening 1448 of the adapter 1400. In other embodiments, the earbuds 1402 may extend through other openings, including dedicated openings such as secondary openings 1450. More specifically, when an earbud 1402 is being removed, it may pass through a corresponding secondary opening 1450 before moving the earbud 1402 to the user's ear.

The adapter 1400 may be formed of any suitable material. In some embodiments, for instance, the adapter 1400 is formed at least partially of a rigid or substantially rigid material, suitable examples of which include metals, alloys, polymers, composites, organic materials, or other materials or any combination of the foregoing. In other embodiments, the adapter 1400 may be fully or partially formed of a flexible or pliable material, including fabrics and flexible polymers, composites and organic materials.

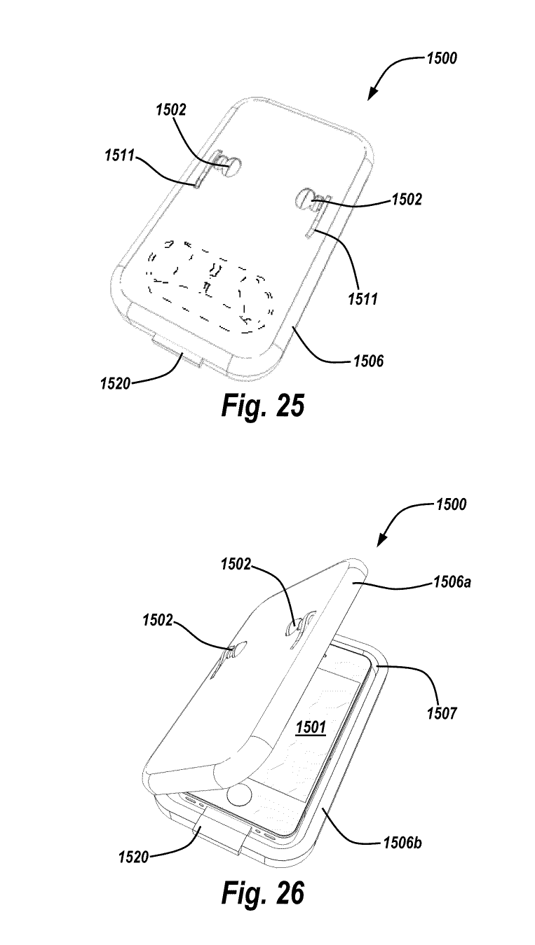

The illustrated adapter 1400 is but one example of an adapter or audio docking station that may be used in connection with embodiments of the present disclosure. FIGS. 25 and 26 illustrate still another example of an audio docking station according to embodiments of the present disclosure. In FIGS. 25 and 26, for example, an audio docking station 1500 is formed as a protective case, or carrying case, for a portable electronic device such as a phone, tablet, computer, e-reader, GPS device, gaming console, or other electronic device as disclosed herein or would be learned from a review of the disclosure herein.

In the illustrated example embodiment, the case 1500 may include a shell 1506 defining a body portion for containing a portable electronic device 1501. The shell 1506 optionally includes multiple components. For instance, the illustrated shell 1506 includes upper and lower portions 1506a, 1506b which can close around an interior cavity 1507 in a clamshell manner. A case 1500 or shell 1506 may have other structures as well. For instance, in another embodiment, the case 1500 may cause the display, access ports, or other portions of the electronic device 1501, to remain visible or accessible while the case 1500 is in place on the device 1501. Thus, rather than a clamshell design, the case 1500 may have a sleeve configuration. Other configurations are also possible, including configurations for storing the device 1501 while it is not in use. In other embodiments the case 1500 may be designed to remain in place while the device 1501 is in everyday or intended use. Thus, the case 1500 may include a wide variety of storage, travel, protective, or carrying cases, device skins, or the like.

In some embodiments, the case 1500 may be configured to act as an accessory that docks to the electronic device 1501 and allows a user to conveniently access or receive audio information. In the illustrated embodiment, the case 1500 includes two receiving portions 1511 configured to retain two earphones 1502 by selectively securing the earphones 1502 to the case 1500. The illustrated receiving portions 1511 may include openings, holes, depressions, snap fits, frictional fits, or other features defined by the shell. In another embodiment, a selectively removable door, window or other feature similar to that illustrated for the computing accessory in FIG. 19 may provide access to an interior compartment of the shell 1506 where the earphones 1502 are located. In at least one embodiment, the door, window or other feature opens to a retention component that may receive an additional audio adapter. For instance, the case 1500 may be an adapter configured to receive and use the audio docking device of FIGS. 1-3 as illustrated in phantom lines in FIG. 25.

In at least one embodiment, the earphones 1502 are accessible and selectively removable from the receiving portions 1511. In particular, embodiments contemplate earphones that may be removed while remaining communicatively linked to the case 1500 or the device 1501. Such link is optionally maintained using a wired connection (e.g., by using retractable cords as disclosed herein), by using a wireless connection (e.g., between the earphones 1502 and a wireless transmitter 1520), or in another manner.

Although the illustrated earphones 1502 are shown as being secured to an exterior surface of the shell 1506, such an embodiment is merely illustrative. In other embodiments, the earphones 1502 could be secured or contained in the cavity 1507 interior to the case 1500, or on other surfaces. In some embodiments, openings extend through a thickness of the shell 1507 so as to allow earphones 1502 contained within the cavity 1507 to pass through the shell 1506 and be used by the user. In accordance with some aspects, the earphones 1502 within the shell 1506 may be secured directly to the case. In other embodiments, the earphones 1502 may be connected to the electronic device 1501 (see, e.g., FIG. 8).

The case 1500 may be a standalone case, adapter or docking station, or may be an accessory for use with another device. For instance, in at least one embodiment, the wireless transmitter 1520 may connect to the wireless device 1501 stored inside the case 1500 so as to electrically or communicatively couple the device 1501 to the case. Information from the electronic device 1501 may then be transmitted through the wireless transmitter of the case 1500 to the wireless earphones 1502. In other embodiments, the wireless transmitter 1520 may not directly connect to the device 1501. For instance, the case 1500 may include an audio input similar to those discussed with regard to FIGS. 5 and 6. In another embodiment, the case 1500 may include storage, power components, or other features that allow the case itself to access and provide audio to the earphones 1502.

It should be appreciated in view of the disclosure herein that the case 1500 may act as an adapter or docking station similar to others disclosed herein. Thus, the case 1500 may be used in similar or identical situations that the adapters and audio docking stations discussed previously with respect to at least FIGS. 1-7 and 22-24.

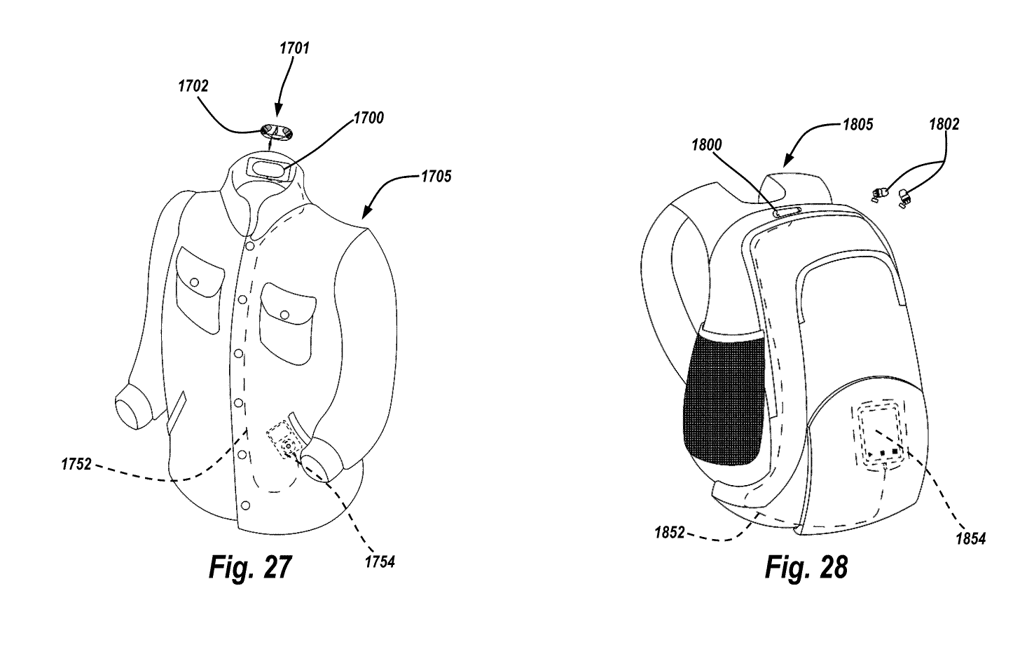

In at least one embodiment, an adapter or audio docking station may be included in a fabric material such as an article of clothing. FIG. 27 illustrates an example embodiment of a shirt 1705 which may be used in connection with embodiments of the present disclosure. In particular, in the illustrated embodiment, an adapter 1700 may be integral and built within the shirt 1705, or may be separately formed and later attached to the shirt 1705. For instance, the adapter 1700 may be made of the same fabric as the shirt 1705 and sewn as a part thereof. In other embodiments, adapter 1700 may be permanently or removably secured to the shirt 1705.

Regardless of the manner in which the adapter 1700 is attached to the shirt 1705, or the type, shape or configuration of the adapter 1700, an audio docking device 1701 may be attached to the adapter 1700 for use with the shirt 1705. In some embodiments, the audio docking device 1701 may be the same device used with another device or apparatus (e.g., the computing device of FIG. 22 or the electronic device of FIG. 26); however, due to the universal nature of the audio docking device 1701 and/or the adapter 1700, the audio docking device 1701 may also be used with the shirt 1705. The audio docking device 1702 may include one or more earbuds 1702, microphones, or other audio input/output devices for use by the wearer of the shirt 1705.

In accordance with one embodiment of the present disclosure, the shirt 1705 may also be designed for use with one or more audio devices. In FIG. 27, for instance, the shirt 1705 may include interior wiring 1752. The wiring 1752 may be conductive wiring capable of carrying audio or other transmitted data. In the particular embodiment illustrated, the interior wiring 1752 may extend from a first location (e.g., a pocket) to a second location (e.g., the collar). The wiring may include connectors to attach to suitable devices. For instance, in the pocket location, a connector may be provided to connect the wiring 1752 to a portable electronic device 1754 capable of accessing or providing audio data. The portable electronic device 1754 may be a telephone, dedicated audio device, e-reader, or any other suitable device, including those disclosed herein. At the collar location a connector may be provided to attach to an audio input of the audio docking device 1701.

While the illustrated embodiment depicts interior wiring and specific connection locations of the wiring to a pocket and/or collar, such features are merely illustrative. In other embodiments, for instance, the shirt may include a wireless transmitter/receiver to eliminate interior wiring. Other embodiments contemplate multiple wiring paths so that any number of locations may be used within the shirt 1705. For instance, each pocket location may include an audio input or output to allow an electronic device 1754 and/or audio docking station 1701 to be connected thereto. Thus, it is not necessary that the audio docking station 1701 be located in the collar. In other embodiments, for instance, the audio docking station 1701 may specifically be located in a pocket location on or even in a fold in the fabric on the interior or exterior of the shirt 1705.

FIG. 28 illustrates another embodiment in which an audio docking station may be used in connection with a portable storage article such as backpack 1805. In the illustrated embodiment, an adapter 1800 may be formed of a flexible or rigid material and located on an outer surface of the backpack 1805, although the adapter 1800 may also be located inside a pocket, under a fold in the fabric, or in any other suitable location. In some embodiments, an audio docking station connected to the adapter 1800 may include wireless earbuds 1802 which are selectively removable therefrom. As a result, when a user is wearing or otherwise has possession of the backpack 1805, the user can use the earbuds 1802 or store the earbuds within an audio docking station in the adapter 1800.

In some embodiments, the backpack 1805 may also include one or more components to facilitate use of the adapter 1800 and the earbuds 1802. For instance, internal wiring 1852 may be provided, along with suitable connectors. In one embodiment, for instance, a pocket or other location of the backpack 1805 includes wiring 1852 along with a suitable connector for attaching to a phone, portable media player, tablet, laptop, e-reader, or other electronic device 1854, or any combination of the foregoing. Wiring may be sewn into the backpack 1805, or otherwise extended therein, and continue to a location proximate the adapter 1800. At such a location, a connector may allow a removable audio docking station to connect to the wiring and thus to the portable electronic device 1854.

While the embodiments in FIGS. 27 and 28 are described as being usable with a removable audio docking station, it should be appreciated that such embodiments are merely illustrative. In other embodiments, for instance, a universal audio adapter may be eliminated such that the audio docking station is directly and integrally connected to the clothing, backpack or other item. In other embodiments, the adapter may be combined with the audio docking station, with both being integral to the article of manufacture.

In accordance with another aspect, an article of clothing, backpack or other similar item may be washable despite the existence of the adapter, wiring, or audio docking station. For instance, where the audio docking station is removable, the adapter may be fabric so as to be washed without a high risk for damage. Before cleaning, the audio docking station and/or portable audio device may be removed and then reconnected after cleaning. For instance, a zipper or other attachment means may be used to connect the audio docking station to the adapter. In other embodiments, the audio docking station is waterproof or water resistant, and can securely maintain the earbuds in place so that even the audio docking station can remain in place when the article is washed.

While FIGS. 27 and 28 specifically relate to a shirt and backpack, respectively, it will be appreciated that such embodiments are merely illustrative. For instance, FIG. 27 may represent a coat, jacket, sweater or any other upper-body article of clothing. In other embodiments, similar or identical features may be used with other articles of clothing such as pants, scarves, earmuffs, gloves, mittens, or other articles. In a similar manner, although FIG. 28 specifically depicts a backpack, other items, including portable storage articles such as hunting packs, hiking packs, camelbacks, fanny packs, laptop cases, briefcases, duffel bags, luggage, purses, or other articles of manufacture, may be used in connection with an adapter, audio docking station or other components consistent with the disclosure herein.

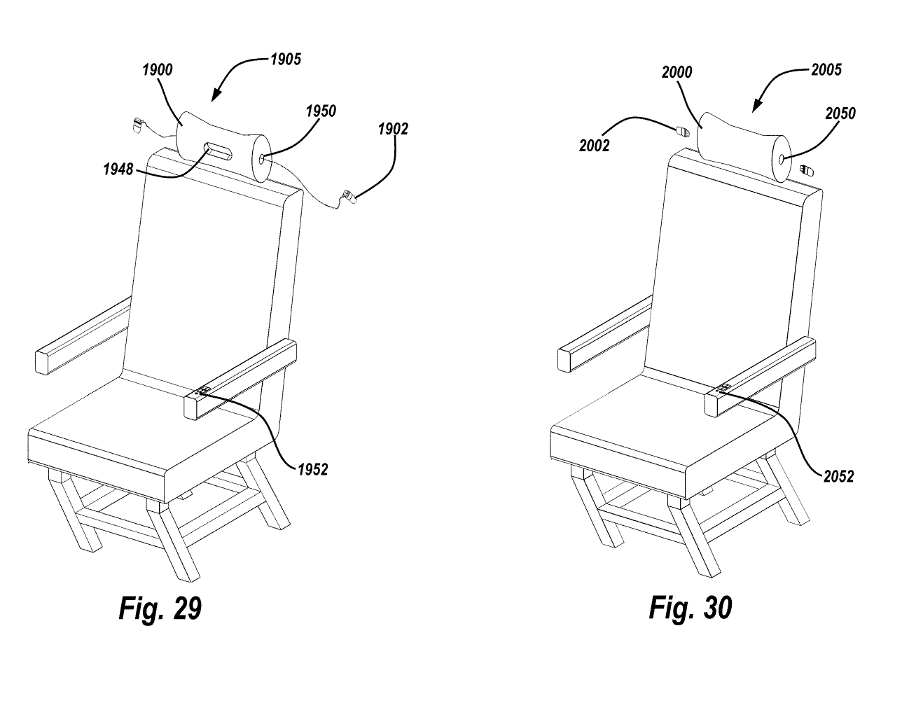

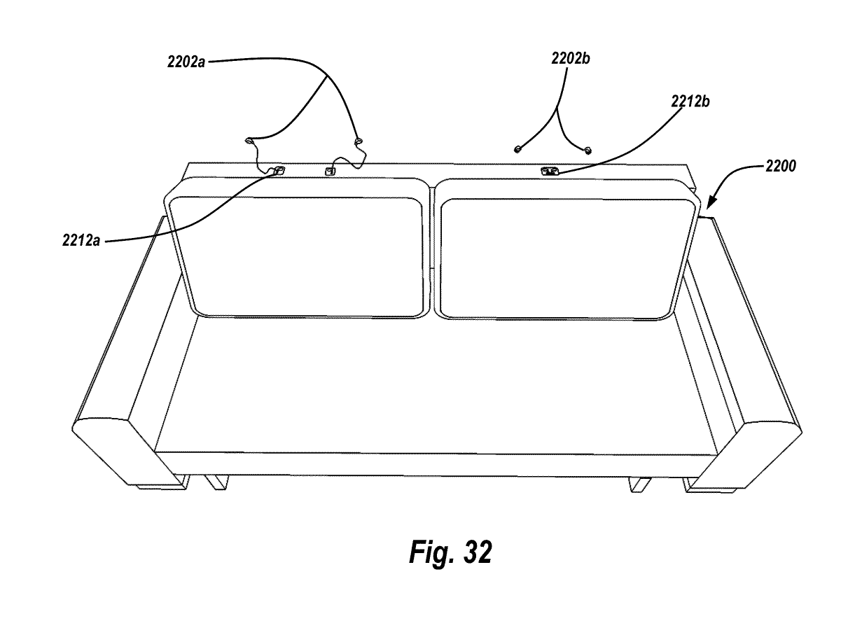

FIGS. 29-32 illustrate still other example embodiments of uses of audio devices and systems according to some embodiments of the present disclosure. In particular, FIGS. 29-32 illustrate use of audio output devices and/or audio docking stations in connection with certain furniture. More particularly, FIGS. 29-31 illustrate embodiments of chairs, and FIG. 32 illustrates an embodiment of a couch, which may use embodiments of the present disclosure. It should be appreciated in view of the disclosure herein that the furniture in FIGS. 29-32 is illustrative only, and other furniture such as desks, beds, tables, and the like may also be used in connection with embodiments of the present disclosure.

FIG. 29 illustrates an example chair 1905 that may be adapted for use with audio input and/or output devices. The chair 1905 is illustrative of any chair that may be used for sitting, including a recliner, a seat in a movie theatre, a desk chair, seating in a vehicle (e.g., an airplane, automobile, boat or other marine vehicle, scooter, motorcycle, all terrain vehicle, or bicycle), stationary or moving exercise equipment, or any other type of seating. Indeed, it should also be appreciated that embodiments are not limited to use with seating. For instance, in a vehicle, an adapter may be provided in a dashboard, door, console, or other location.

In the illustrated embodiment, the chair 1905 includes an optional headrest 1900. In some embodiments, the headrest 1900 may include, or act as, an adapter for an audio docking station. For instance, the headrest 1900 may functionally operate in a manner similar or equivalent to the adapter 1400 discussed above.

In the illustrated embodiment, the headrest 1900 includes or defines an opening 1948. The size, shape and configuration of the opening 1948 may correspond to an audio docking station. To provide a more clear view of the headrest 1900, a body portion of the audio docking station is not illustrated, but may generally be similar to the body of any audio docking station described or illustrated herein. The headrest 1900 may also include optional secondary openings 1950. In one embodiment, the secondary openings 1950 may be on opposing sides of the headrest 1900, or in another suitable location so as to allow earbuds 1902 of the audio docking station to be extended therethrough. From such a position, the earbuds 1902 can be positioned inside or on the ears of a user of the chair 1905.

An electrical or communicative connection is optionally established between the audio docking station and the headrest. For instance, in one embodiment, an audio connector of the audio docking station mates with a corresponding audio connector of the headrest 1900 when the audio docking station is permanently or removably secured to the headrest (e.g., within opening 1948). In some embodiments, wiring, audio transducers, wireless transmitters/receivers, or other electrical components may be included as part of the chair 1905. By way of example, an audio connector within the headrest 1900 may connect to wiring extending through a portion of the chair 1950. In some embodiments, the wiring may extend to an audio input connector 1952 which is illustratively depicted in an armrest of the chair 1905, although an audio input could be positioned in any suitable one or more locations. When an audio docking station optionally connects to the headrest 1900, the wiring may thus provide a communication link between the connector 1952 and the earbuds 1902 of the audio docking station. An audio device (not shown) may then provide an input to the audio connector 1952 to provide sound that is ultimately conveyed through the earbuds 1902.

Although the illustrated embodiment depicts the headrest 1900 as having an opening 1948 at a front side thereof, it should be appreciated that such an embodiment is merely an example and not limiting of the present disclosure. For instance, in other embodiments an opening or other means for connecting the adapter to an audio docking station may be located elsewhere, including on a top, side, rear or underside of the headrest 1900. In other embodiments, the opening 1948 may be on the front of the headrest 1900 but covered with a flap of material or cushioning. Such material or cushioning may serve to ensure the headrest is comfortable to the user notwithstanding the presence of the opening 1948 and/or an audio docking device. In still other embodiments, an adapter or audio docking station may be positioned in a location other than the headrest 1900. For instance, an adapter may be located in a seatback, arm, or other location of the chair, or even in a different chair altogether. For instance, in an airplane or movie theater, the user may connect an audio docking device to a back of a chair in front of the user.

FIG. 30 illustrates another embodiment of a chair 2005 in which a headrest 2000 is configured to facilitate the provision of audio to a user thereof. In the illustrated embodiment, the headrest 2000 includes a set of secondary openings or cavities 2050 on the sides thereof. The openings or cavities 2050 may be defined by the headrest to have a particular size and shape. In accordance with at least one embodiment, the size and shape of the openings or cavities 2050 may generally match one or more earbuds 2002.

In some embodiments, the headrest 2000 may act as the audio docking station, or a portion thereof, rather than as an adapter for use with an audio docking station. For instance, in FIG. 30, the earbuds 2002 may fit directly into the openings or cavities 2050 and are optionally secured therein when not in use. The earbuds 2002 may be wireless, although in other embodiments they earbuds 2002 may use conductive wires to receive sound. In a wireless embodiment, the earbuds 2002 may include wireless audio receivers.

A wireless audio transmitter may be included within the headrest 2000, another component of the chair 2005, or in another suitable location. In at least one embodiment, an audio connector 2052 is provided on, or associated with, the chair 2005 and configured as an audio input. When connected to an audio output of an audio device, sound may be received by the chair 2005. Where there earbuds 2002 are wireless, the received sound may be provided to the wireless transmitter which sends the sound to the earbuds 2002. For wired earbuds 2002, a wired connection may extend fully from the audio input to the earbuds 2002. In still another embodiment, a combination of wired and wireless connections or communication channels may be used.

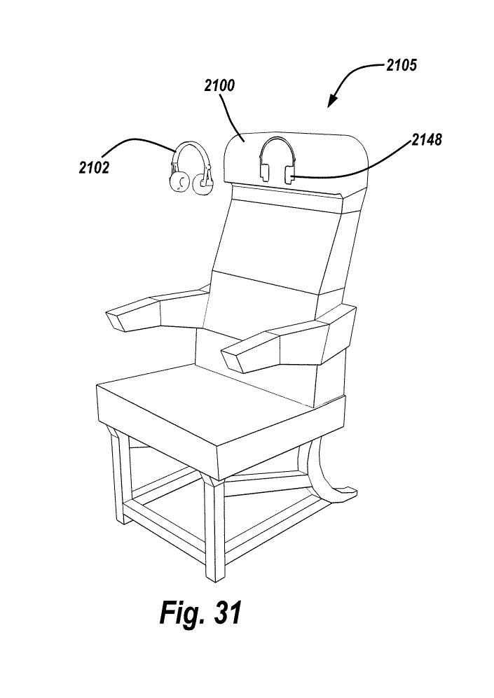

Turning now to FIG. 31 another example embodiment of an audio system is illustrated according to some aspects of the present disclosure. FIG. 31 provides a perspective view of an example chair 2105 usable with one or more audio outputs 2102. As shown in the illustrated embodiment, the audio output 2102 may include a set of headphones. Accordingly, although various embodiments illustrated or described herein are specifically disclosed as including earbuds, such discussion is merely illustrative and different components or terminology may be used. Accordingly, the terms “earbuds”, “headphones”, “earphones” and the like should be considered to be interchangeable. Moreover, such devices may include any number of different features or functions, including varying degrees of audio quality. In other embodiments, audio components may be water resistant, or have other capabilities or functions.

In the illustrated embodiment the chair 2105 includes a seatback attached to a headrest portion 2100. The illustrated headrest portion 2100 may include a cavity 2148 defined therein. In accordance with one embodiment, the cavity 2148 may have a shape and size allowing the headphones of the audio output 2102 to be positioned therein, and optionally to be securely but removable positioned therein. In operation, the audio output 2102 may be positioned in the headrest portion 2100 for storage or when not in use, and then removed from the cavity 2148 to allow or facilitate use by a user. The audio output 2102 may operate using wireless communication protocols or may use a wired connection. Where a wired connection is used, a conductive wire is optionally retractable or otherwise storable within the cavity 2148 and/or the chair 2105.

In some embodiments, the chair 2105 may operate in a manner similar to embodiments of audio docking stations disclosed herein. For instance, the chair 2105 may include an audio input, optionally in the form of a male or female plug or connector. Such audio input may be located in any number of different locations, including in the headrest portion 2100, a seatback, an arm, or even in an adjoining seat. In other embodiments, the chair 2100 may not include an audio input. Rather, the headphones 2102 may be synced or paired with an electronic device having its own transmitter or other audio output for transferring sound to the audio output 2102.

While the storage location for the headphones is illustrated as being in the headrest portion 2100, it should be appreciated in view of the disclosure herein that such location and storage is merely illustrative. In other embodiments, for instance, a shelf, tray or other storage location may be used, or the storage location of whatever type may be located in the seatback, arm rest, in an adjacent seat, in an overhead compartment, or in any other suitable location. Where the audio output 2102 is in the headrest portion 2100 or another location against which a user may sit, the chair 2105 and/or audio output 2102 may include components to enhance user comfort. For instance, the headphones of the audio output 2102 may be provided with a cushioning material on an outer surface thereof so as to provide a soft surface against which the user may place his or her head or other portion of the body. In other embodiments, the chair 2105 may include separate cushioning material to be placed in the cavity 2148 and exterior to the audio output 2100, or a flap of material may be provided to cover the cavity 2148.

FIG. 32 illustrates still another embodiment for use as an audio system. In the illustrated embodiment, a couch 2200 may include one or more integrated audio components that provide for a user to conveniently have access to audio in a personalized environment. More particularly, the couch 2200 may include one or more sets of audio output devices 2202a, 2202b integrated therewith. In one embodiment, the audio output devices 2202a, 2202b may include earbuds, earphones, headphones or the like. Such devices may be used by a single person to have personal access to audio from an audio output device. If multiple sets of audio output devices 2202a, 2202b are included in the couch 2200, each set may be configured for independent use, or for collective use with the same audio output system. In some embodiments, use may be both individual and collective based on a user's preferences.

In the example embodiment of FIG. 32, the couch 2200 includes a first set of audio devices 2202a, which are illustrated as earbuds connected to the couch 2200 via one or more conductive wires. The wires may extend into or otherwise attach to the couch 2200, and the couch 2200 may include additional components for transferring sound to or from the audio devices 2202a. For instance, wiring may be embedded within the couch 2200. A transmitter, audio transducer, input or output port, or other component may be communicatively linked to the wiring.

The audio devices 2202a are optionally storable in or on the couch 2200. By storing such devices on or in the couch 2200, the audio devices 2202a may be available for use any time by a user of the couch 2200, thus enhancing the convenience of the audio components. For instance, if a user wishes to listen to music, television, or some other audio programming, the user need not carry around a separate set of earphones or audio outputs, but can simply use those already provided in the couch 2200.

To facilitate storage of the audio devices 2202a, the couch 2200 may include one or more storage locations 2212a. Storage locations 2212a may have any form, including those discussed herein. For instance, in one embodiment, the storage locations 2212a may be of a universal nature to receive a removable audio docking station. In other embodiments, such as that illustrated in FIG. 32, the storage locations 2212 may be integral with the couch 2200. The storage locations 2212a may include a cavity, opening, shelf, window or other location on an arm, seat cushion, chair back, or in another location. Each storage location 2212a may correspond to one earphone or other audio device 2202a, or a single storage location 2212a may receive multiple audio devices 2202a.

Also illustrated in FIG. 32 is an example set of wireless audio devices 2202b that may be used in connection with the couch 2200. Similar to the wired audio devices 2202a, the wireless audio devices 2202b are optionally storable within or on the couch 2200 and/or connectable to audio components within the couch 2200 to enable convenient and simple use. In the embodiment in FIG. 32, both wireless audio devices 2202b may be storable within a single storage location 2212b. In such an embodiment, the storage location 2212b may permanently or releasably receive an audio docking station, or directly receive the audio devices 2202b. In some embodiments, the storage location 2212 may be configured to provide power for a charging station or for other purposes.

As will be appreciated by one skilled in the art in view of the disclosure herein, the couch 2200 may include wires, transmitters, connectors or other components to allow transfer of sound data from an audio source to the audio devices 2202a, 2202b, or even from the audio devices 2202a, 2202b such as where one of the audio devices 2202a, 2202b includes a microphone. Often, the audio will be provided from or to an outside source. Non-exclusive examples of outside sources of sound data may include televisions, laptops, tablets, e-readers, telephones, media players, Internet devices, portable media players, and the like. In other embodiments, however, the couch 2200 itself may provide sound data by, for instance, being integrated with electronic components for storing or accessing sound data.

Aspects of the present disclosure provide for convenient use of audio input/output devices by a user. Some embodiments additionally, or alternatively, also provide the ability to integrate such devices within other devices, systems or apparatus. Such integration may allow discrete use of the audio devices, ease of storage or access, or any number of other features. In some embodiments, the audio devices may also be interchangeably used with a number of different devices, and even integrated with such devices.

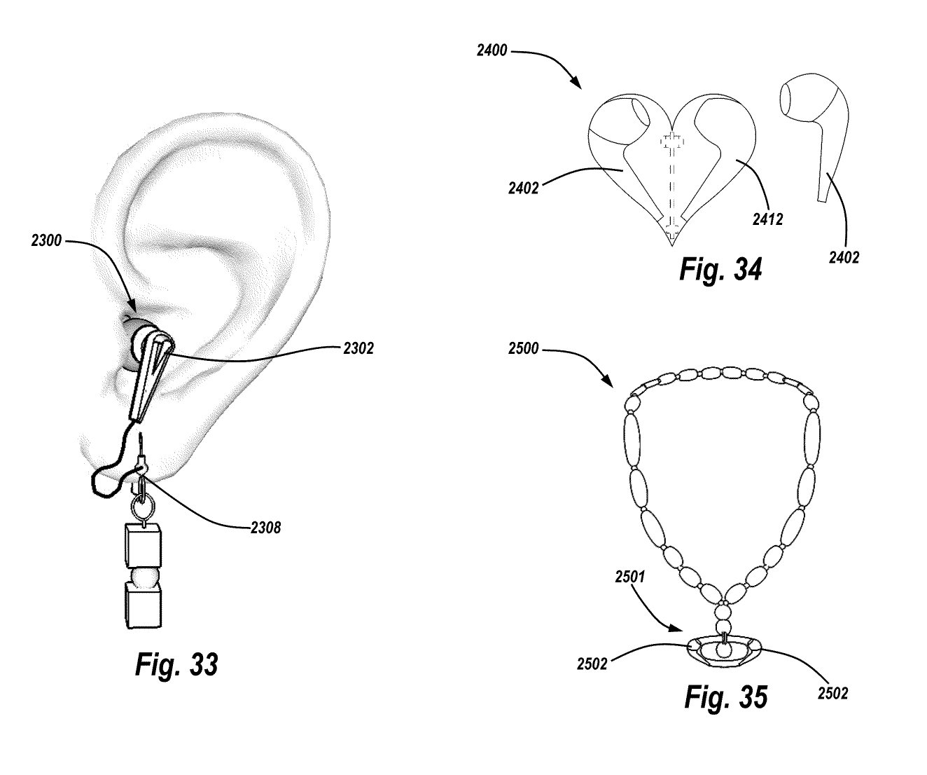

FIGS. 33-37 illustrate some additional embodiments of audio devices and systems that provide for use of audio devices in a convenient and/or discrete manner. In particular, FIGS. 33-37 illustrate integration of audio systems or components with jewelry or other wearable accessories, although the same principles may be applied to any number of industries. Examples of other industries that may benefit from the principles disclosed herein include the costume, hairpiece, accessories, cosmetics, and sports and fitness industries.

Specifically referring to FIG. 33, convenient use of an audio device such as an earphone 2302 may be provided by integrating the device with an earring. In one embodiment, for instance, the audio system 2300 includes an earphone 2302 as well as a wireless receiver or transmitter 2308. The audio system 2300 may be stored or used in isolation, although in other embodiments the audio system 2300 may be used in connection with an audio docking station according to the principles disclosed herein.

The earring audio system 2300 is optionally designed to maintain a desired aesthetic appearance while also providing enhanced convenience for use of the earphone 2302. In accordance with one aspect, such aesthetic purposes may be satisfied by reducing the size of the earphone 2302 so it is more difficult to see within the person's ear and/or reducing the width or size of a wire extending between the earphone and the wireless receiver/transmitter 2308. In some embodiments, the wireless receiver/transmitter 2308 may serve multiple purposes. For instance, the stud for the earring may also serve as the wireless receiver/transmitter 2308. In other embodiments, the wireless transmitter/receiver 2308 may be integrated in dangling decorative portions of the earring 2300. Embellishments or other components may include designs, jewels, precious stones, glasswork or any other design or component, or any combination of the foregoing, either separate from, or integral with, the wireless receiver/transmitter 2308.

Another convenient audio system is illustrated in FIG. 34, which illustrates an example brooch 2400 that may provide a decorative appearance as well as access to audio components. In the illustrated embodiment, for instance, the brooch 2400 may include a housing defining one or more cavities 2412 or other storage locations. Optionally, the cavities 2412 or other storage locations are designed to correspond to the size and shape of one or more audio components 2402, which may include earphones, microphones, other audio components, or any combination of the foregoing. The body of the brooch 2400 may optionally act as a wireless transmitter or wireless receiver in embodiments in which the audio components 2402 are earbuds, earphones, headphones, hearing aids, microphones, or the like.

In the illustrated embodiment, the audio components 2402 have a size that can generally be integrated within the brooch 2400. When the audio component 2402 is removed from the brooch 2400 (e.g., so as to be used by the user to receive or transmit sound), the brooch 2400 may generally retain its desired shape and decorative appeal. The cavities 2412 may be on the exterior of the brooch 2400, such as in the manner illustrated in FIG. 34. In other embodiments, an interior cavity may be provided, such as in the case where the brooch 2400 also serves as a locket.

Optionally, the brooch 2400 can be used as such, or connected to a chain and used as a necklace. In other cases, a necklace may include a pendant or other component not intended for use as a brooch. For instance, FIG. 35 illustrates an example necklace 2500 which includes a pendant 2501 configured to allow convenient access to, and use of, one or more audio devices 2502. In this embodiment, audio devices 2502 such as headphones, earbuds, earphones, microphones, hearing aids, or the like may be stored on the pendant 2501. The audio devices 2502 may be selectively removable to facilitate use in receiving or providing sound. In some cases, the pendant 2501 may be an audio docking station similar to those disclosed herein, and optionally removable from the necklace.

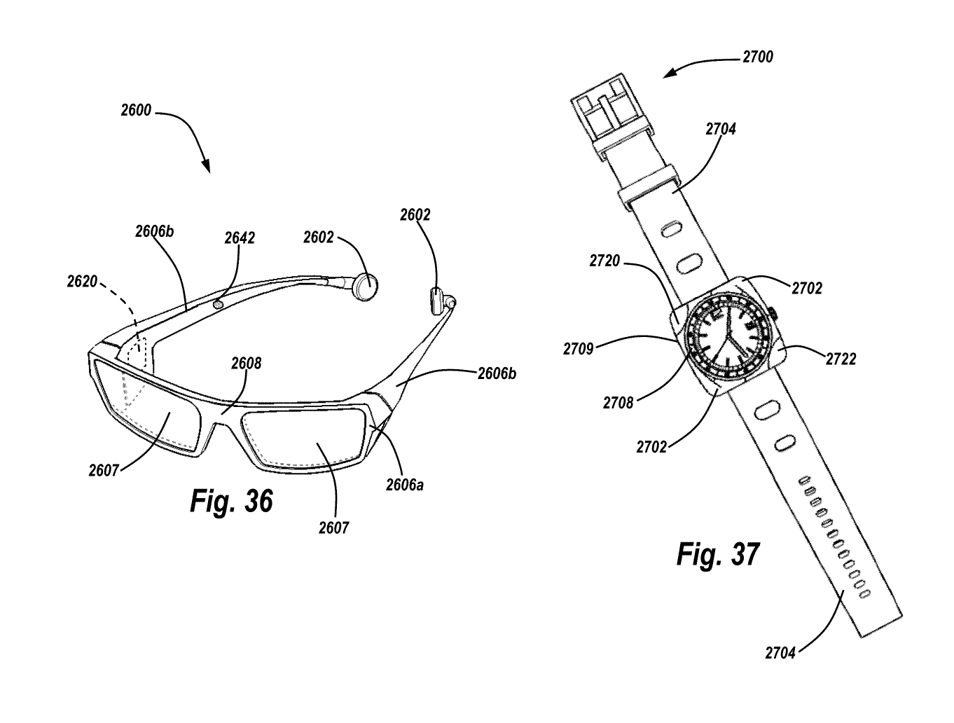

FIG. 36 illustrates an example embodiment of a set of eyeglasses 2600 which may provide for use of audio components in accordance with embodiments of the present disclosure. The eyeglasses 2600 are illustrative of a number of different types of glasses, including prescription eyeglasses, reading glasses, sunglasses, costume glasses, goggles, or virtually any other type of eyewear. In the illustrated embodiment, the eyeglasses 2600 may include a frame 2606a configured to hold a pair of lenses 2607. The frame 2602 may include a bridge 2608 between the lenses 2607, which bridge may optionally be configured to rest on or above a wearer's nose.

To facilitate use by the wearer, the frame 2606a may be connected to a pair of elongated temples 2606b configured to extend from the front of the wearer's face to above, and potentially behind, the wearer's ears. As shown in FIG. 36, the eyeglasses 2600 optionally include one or more audio components. For instance, in the illustrated embodiment, a set of earphones 2606 may be selectively connected to the end pieces of the temples 2606b. The earphones 2606 may be secured in place or may be selectively extendable or removable. By way of illustration, the earphones 2602 may be connected to the temples 2606b using a selectively retractable wire. In other embodiments, the earphones 2602 are wireless earphones and may be removed entirely from the temples 2606b. To connect the earphones 2602, a snap fit, frictional fit, suction, or other type of connection may be used.

An optional wireless transmitter 2620 may also be included within the eyeglasses 2600. Such a transmitter 2620 may be placed on the frame 2606 or on one or more of the temples 2606b. In one embodiment, the wireless transmitter 2620 may be located at or near the bridge 2608 of the eyeglasses. The wireless transmitter may be used to access and/or provide audio to the earphones 2602. In at least some embodiments, the transmitter 2602 may be replaced or supplemented with a memory device so as to allow audio or other programming to be stored on the eyeglasses 2600.

Where audio or information is stored in memory on the eyeglasses 2600, a user interface may optionally be included to allow selection of stored audio. In other embodiments, wired or wireless connections to other audio sources may also be provided. In accordance with at least one embodiment, the eyeglasses 2600 include multiple types of audio components. For instance, FIG. 36 illustrates an optional speaker or microphone component 2642 embedded within a temple 2606b. Such a component 2642 may output audio information or receive audio information. In the case of a microphone, the transmitter 2620 may also act as a receiver to receive the information, and then as a transmitter to transmit the information to another source that may be independent of the earphones 2602. Additionally, while the component 2642 is shown as being embedded in a temple, this is merely illustrative. In other embodiments, the audio component 2642 may also be removable and/or wirelessly coupled to the transmitter/receiver 2620. In at least one embodiment, a portion of the temple 2606b or other portion of the eyeglasses 2600 is flexible, hinged, or otherwise movable to allow selective placement of the audio component 2642.

FIG. 37 illustrates an example timepiece 2700 which includes a face 2708 configured to allow a user to tell time. In this embodiment, the face 2708 is a watch face and the time piece 2700 is a watch that includes a watch band 2704 secured to the face 2708. The timepiece 2700 may be configured to allow convenient access to, and use of, one or more audio devices 2702. In this embodiment, audio devices 2702 such as headphones, earbuds, earphones, microphones, hearing aids, or the like may be stored on the watch 2700. The audio devices 2702 may be selectively removable to facilitate use in receiving or providing sound. In some cases, the watch 2700 may be an audio docking station similar to those disclosed herein, and optionally removable from the watch band 2704.

The watch face 2708 may have a frame 2709 located therearound. In the illustrated embodiment, the frame 2709 is structured to selectively secure the earphones 2702 in place on the watch 2700. The frame 2709 and earphones 2702 may provide an optional decorative appearance in which the earphones 2702 minimally detract from the aesthetic qualities of the watch 2700. The frame 2709 or other portion of the watch 2700 may also optionally include a transmitter 2720 or controls 2722 to facilitate use of the earphones 2702 in receiving audio information.

According to embodiments of the present disclosure, the audio devices of FIGS. 33-37 may use wireless transmitters or receivers, and such components are optionally integrated within the respective earrings, brooches, necklaces, eyeglasses, or timepieces. In other embodiments, such wireless components may be otherwise located. For instance, an audio docking station or other corresponding audio component may have a wireless transmitter/receiver for communicating with the audio devices in jewelry or other wearable items. In still other embodiments, such a wireless transmitter/receiver may be in another, separate item. For instance, the necklace 2500 of FIG. 35 may be matched with the watch of FIG. 37, the eyeglasses of FIG. 36, the brooch of FIG. 34, the earrings of FIG. 33, a corresponding bracelet (not shown). An associated wireless transmitter/receiver in any of the other devices may communicate with the wireless transmitter/receiver in the earphones 2502 from the necklace 2500. In still other embodiments, wireless components may be removed or minimized by using conductive wires capable of carrying audio signals.

Embodiments disclosed herein may provide a user with various benefits over traditional or currently available audio systems, devices, components and accessories. For instance, as discussed herein, audio components such as earbuds, microphones, hearing aids, and the like may be integrated within an audio docking station to allow convenient use of the audio components with any number of different electronic or non-electronic devices. Audio components may also be integrated directly into other objects, and optionally retractable or storable therein, so as to allow convenient access without requiring the user to always carry a set of earphones or the like. In the same or other embodiments, audio components may be hidden or discretely located to allow use without an undesired visual effect that makes use of such audio components overtly obvious. In some embodiments, electrical devices or other objects may include a cavity or other feature to allow modular components to be connected thereto. Modular components may include earphones, a docking station, or still other components.

Although the foregoing description contains many specifics, these should not be construed as limiting the scope of the disclosure or of any of the appended claims, but merely as providing information pertinent to some specific embodiments that may fall within the scopes of the disclosure and the appended claims. For convenience, aspects of the present disclosure have been illustrated or described in connection with specific embodiments; however, the discussion should not be interpreted as requiring or allowing certain features only in combination with other features or elements. Indeed, features from any of the various embodiments may be employed in combination, and may supplement other features or replace other aspects or features. In addition, other embodiments of the present disclosure may also be devised which lie within the scopes of the disclosure and the appended claims. The scope of the present disclosure is, therefore, indicated and limited only by the appended claims and their legal equivalents. All additions, deletions and modifications to example embodiments, as disclosed herein, that fall within the meaning and scopes of the claims, are to be embraced by the claims.

What is claimed is:

1. An audio docking station, comprising:
a body defining at least one storage location;
at least one audio output device configured to be removably secured within the at least one storage location; and
at least one audio input device communicatively linked to the at least one audio output device.

2. The audio docking station of claim 1, wherein the at least one audio output device is communicatively linked to the at least one audio input via one or more of a wired connection or a wireless connection.

3. The audio docking station of claim 1, wherein the at least one audio output device or at least one audio input device is retractable relative to the body.

4. The audio docking station of claim 1, further comprising:
attachment means for securing the body to an adapter or sound pouch.

5. The audio docking station of claim 1, wherein the at least one audio output device includes at least one earphone and the at least one audio device includes a male connector.

6. The audio docking station of claim 1, wherein the body or at least one audio output device define at least a portion of a portable electronic device, a computing device, a display device, a media card, a USB device, a universal dock, furniture, a storage or protective case for an electronic device, eyeglasses, a timepiece, or jewelry.

7. An electronic device comprising:
a housing;
one or more audio communication components within the housing, the one or more communication components being capable of transferring audio data;
at least one audio output communicatively coupled to the one or more audio communication components;
at least one audio input communicatively coupled to the one or more audio communication components; and
at least one storage compartment integrated within the housing, the at least one storage compartment being configured to selectively receive the at least one audio output or the at least one audio input in a storage configuration.

8. The electronic device of claim 7, wherein the at least one audio output includes one or more earphones, and wherein the at least one storage compartment includes a storage location for selectively maintaining the one or more earphones in the storage configuration.

9. The electronic device of claim 7, wherein the at least one audio input component includes a male audio connector.

10. The electronic device of claim 9, wherein the at least one storage compartment includes a storage location for selectively maintaining the male audio connector in the storage configuration.

11. The electronic device of claim 7, wherein the electronic device is a portable electronic device.

12. The electronic device of claim 11, wherein the portable electronic device is a telephone, a music player, an e-reader, a gaming console, a camera, a laptop computer, a netbook, a GPS device, a two-way portable radio communication device, a tablet, an Internet device, a projector, a singing or karaoke machine, a Dictaphone, a portable digital assistant, a calculator, a pager, a radio alarm clock, a time piece, a keyboard, a mouse, or a gaming controller.

13. The electronic device of claim 7, wherein the electronic device is a desktop computing device, a server, or a gaming console.

14. The electronic device of claim 7, wherein the at least one audio output includes a wire connecting the at least one audio output to the one or more audio communication components, the wire being retractable with respect to the housing.

15. The electronic device of claim 7, wherein the at least one audio input includes a wire connecting the at least one audio input to the one or more audio communication components, the wire being retractable with respect to the housing.

16. The electronic device of claim 7, wherein the at least one audio output includes a wireless connection to the at least one audio input of the one or more audio communication components.

17. The electronic device of claim 16, the at least one storage compartment being configured to provide power charging a wireless component of the at least one audio output.

18. The electronic device of claim 7, the electronic device being configured to act as an audio pass-through device when the electronic device is in a powered off state.

19. An adapter for connecting to an audio docking station, the adapter including:
a body portion;
a receiving portion cooperating with the body portion to define an area configured to connect to an audio docking station; and
an attachment mechanism configured to secure the audio docking station to the body portion.

20. The adapter recited in claim 19, wherein receiving portion includes a cavity defined by the body portion.

21. The adapter recited in claim 20, wherein the cavity is configured to have the audio docking station placed or slid therein.

22. The adapter recited in claim 19, wherein the body defines at least one opening configured to coincide with one or more extendable audio output devices of the audio docking station.

23. The adapter recited in claim 19, wherein the receiving portion includes a connector configured to correspond to a location of an audio input or output connector of the audio docking station and to communicatively couple thereto.

24. The adapter recited in claim 19, wherein the adapter is located on or within furniture, an article of clothing, a portable storage article, a non-portable electronic device, a portable electronic device, a storage case for an electronic device, or a protective cover for an electronic device.
